(19) United States
(12) Patent Application Publication
(10) Pub. No.: US 2026/0258778 A1
(43) Pub. Date: Sep. 3, 2026

(54) STRUCTURE WITH SERRATIONS ADAPTED TO TRAVERSE A FLUID ENVIRONMENT

(71) Applicant: BIOMERENEWABLES INC., Toronto (CA)

(72) Inventors: Ryan CHURCH, Toronto (CA); Evan CHOU, Toronto (CA)

(21) Appl. No.: 18/942,094

(22) PCT Filed: Nov. 22, 2023
(86) PCT No.: PCT/CA2023/051565

§ 371 Date: Nov. 8, 2024

Related U.S. Application Data
(60) Provisional application No. 63/427,660, filed on Nov. 23, 2022.
(60) Provisional application No. 63/457,637, filed on Apr. 6, 2023.

(51) Int. Cl. F03D 1/06

(52) U.S. Cl. CPC F03D 1/06495; F03D 1/0645; F05B 2240/3042; F05B 2260/962

(57) ABSTRACT

There is provided an airfoil with a plurality of alternating projections and troughs along its trailing edge designed to traverse a fluid medium. The airfoil described uses the plurality of projections and troughs to negate noise, which is a function of wind speed and chord length. In an alternate variation, instead of, or in addition to negating noise, the plurality of projections and troughs instead are adapted to produce or modify noise such that it is generated in a desired frequency band. In this variation, the plurality of projections and troughs are structured such that the generated noise is in the desired frequency band that is based at least on a frequency band that is repulsive to various types of animals given a designated local wind speed. In another variation, the plurality of projections and troughs instead are adapted to improve the aerodynamic performance of the airfoil, either taken alone, or in the context of multiple airfoils working together within a system.

### CROSS-REFERENCE

This application is a National Stage of International Application No. PCT/CA2023/051565, filed 22 Nov. 2023, which is a non-provisional of, and claims all benefit, including priority to, U.S. Application No. 63/427,660, filed 23 Nov. 2022, entitled “STRUCTURE WITH SERRATIONS ADAPTED TO TRAVERSE A FLUID ENVIRONMENT”, and U.S. Application No. 63/457,637, filed 6 Apr. 2023, entitled “STRUCTURE WITH SERRATIONS ADAPTED TO TRAVERSE A FLUID ENVIRONMENT”. Both of these applications are incorporated herein by reference in their entirety.

### FIELD

This application relates to an aerodynamic/aero-acoustic structure. The proposed structure is adapted for noise modification (e.g., reduction, shifting) during operation of the aerodynamic structure. The proposed aerodynamic structure can be retrofitted onto or integrated into an airfoil to provide a series of projections and troughs.

### INTRODUCTION

Airfoils, and their related aerodynamic characteristics, are mechanical devices which can be operated as power producing machines, such as wind turbines, or transportation devices such as aeroplanes or drones and structures to move air such as cooling fans.

An undesirable aspect of airfoils in operation is the generation of undesirable noise. The noise occurs as a result of the airflow interacting with the physical airfoil components. Noise emissions from the rotor blade either come from the tips, called tip vortex noise, or from the trailing edge near, but not at, the tip.

Rotor blade noise has been found to mostly consist of trailing edge noise and comes in two varieties—blunt trailing edge noise, or “B-TE” noise, and turbulent boundary layer trailing edge noise, or “TBL-TE” noise, with TBL-TE being the largest cause for rotor blade noise emissions.

TBL-TE is caused by scattering of turbulent fluctuations within the blade boundary layer at the trailing edge, resulting in radiation of broad-frequency noise.

It would be useful to enhance the structure of a rotor blade in an attempt to reduce or modify TBL-TE rotor blade noise emissions.

### SUMMARY

According to an aspect, there is provided an airfoil with a plurality of alternating projections and troughs along its trailing edge designed to traverse a fluid medium, the airfoil comprising an elongate body having a root end, a tip end, a pressure side, a suction side, a leading edge and a trailing edge separated by a chord length. The airfoil described uses the plurality of projections and troughs to negate noise (e.g., trailing edge noise), which is a function of wind speed and chord length.

The alternating projections and troughs, in operation, have specially adapted geometries that are adapted for noise modification (e.g., noise reduction). The geometries that can be established have axial spacing, distances between troughs, among others. The alternating projections and troughs can be provided in the form of a double-peaked serration, where a first peak and a second peak can have different heights. There can be a “primary” trough established between discrete serrations, and a “secondary trough” established between the first and the second peak (e.g., at the midpoint or any another point between the first and the second peak). Each of these peaks and their corresponding geometries can be adapted to provide an improved serration that causes noise modification in respect of a target frequency or a target band of frequencies (which may also be impacted by the wind speed at a particular chordal section of a turbine).

The serrations carrying the projections and their troughs can be retrofit or otherwise attached onto the trailing edge of a body traversing the fluid, such as a wind turbine blade. The specific geometry can be pre-defined based on expected wind speeds, sound frequencies to be modified, etc. In some embodiments, the geometry can have a limited passive ability to shift in shape, for example, through selection of temperature sensitive materials. This is useful where the temperature impacts the wind speeds and/or frequencies of interest.

Compared to solid/flat trailing edges where all the air flowing under the airfoil and then mixing with all of the air flowing over the airfoil at the same chordwise location, the serrations operate by spreading out the mixing of the air over a larger area, and prevent the turbulent nature of the mixing to occur all at once in one location. This dissipates the energy differentials of the two flows over a greater timespan, thus reducing the threshold for turbulent sound formation.

Through the proposed approach, some of the air will instead mix at the troughs. If these troughs are separated by a distance d′ equal to half a sound wavelength, the noise at that wavelength will experience destructive interference, and noise at adjacent wavelengths will experience a progressive reduction equal in intensity following a parabolic relationship, and can thus have a technical effect of modifying (e.g., reducing) the overall sound generation.

In some embodiments, the noise at a particular wavelength, instead of being attenuated, is shifted to a different, either less harmful/undesirable frequency, or potentially shifted to a useful frequency (e.g., for animal deterrence). Reductions in w′ or w″ bounded by practical limitations in production and use can have beneficial technical effects in allowing for more destructive interference to occur, and in targeting more frequencies of interest. Alterations in d″ can have impacts on reduced eddy flow by allowing air to mix at alternating axial positions. This can further reduce noise proliferation and impact tonal aspects of the noise that is emitted.

Allowing for air to mix at different axial positions behind a rotor blade may be advantageous in that it reduces eddy formation which in turn may improve the wake behind the turbine by increasing mixing and reducing drag. The formation of eddies can have a negative effect on aerodynamics and the threshold for eddy formation is reduced by offsetting peaks at different axial positions. This is to say, that the energy required for eddy formation is less when the axial position is spaced out over a longer time space. This is a feature of Time Dependent Energy Transfer, a physics phenomenon first described by the present inventor.

d″ is the difference in height between two peaks. d″ alterations lead to one peak being higher than the other, which creates different axial positions for air to mix. For example, d″ can be measured as the height of the left peak subtracted by the height of the right peak, with positive values indicating that the left peak is higher, and negative values indicating that the right peak is higher. As noted, the different axial positions impact eddy flow as there are alternating axial positions for flow. These impact noise proliferation and impact tonal aspects of noise by shifting sound made from one frequency to another. In particular, it can be desirable to shift lower frequency noise to higher frequency noise as the noise travels less far from the turbine or it attenuates in atmosphere faster than low frequency noise (e.g., shorter wavelength). There are different versions of d″ configurations contemplated.

In first embodiment, each d″ has the same orientation, meaning that the left peak or the right peak is consistently higher than the other. In a second embodiment, each d″ may have an opposite orientation, meaning that the serrations alternate between the left and the right peak being higher. For example, in the first embodiment, d″ is always a positive or a negative value. In the second embodiment, d″ alternates between positive and negative values (e.g., left is higher then right is higher, and so on).

d″ values or configurations can be constant across the serrations, or in some embodiments, may be continuously shifting depending on the identified outcome at a particular point along the blade based on the distance from the hub, for example. In another variation, there are separate sections each having a different d″ value or configuration. This variation is easier to manufacture but is less targeted than a continuously varying version for each serration, but both can be useful in improving the noise properties of the turbine blade.

Finally, each section can also have different configurations, and this may be dependent on the type of fluid flow experienced at each section. The value/configuration for d″ can be determined based on a combination of contributing factors from d′, w′, and w″ as each of these may contribute to the overall noise adjusting properties of the serrations. For example, d′, d″, w′, and w″ can be all selected together such that the overall noise modification for the turbine or a turbine farm as a whole matches a desired outcome, recognizing that the selection of d′, d″, w′ and w″ can also have other impacts on lift, drag, weight, or other aerodynamic factors relevant to operation. For example, d″ can be selected or configured in an attempt to shift undesirable sound into frequencies that potentially deter animals.

The values of d″ in a further embodiment are based on its local radial position, and thus the local flow speed given the RPM and TSR of the turbine. This, in combination with atmospheric effects, such as air density, temperature and humidity, can impact the performance of the serration, given a specified”.

Reducing trailing edge turbulence and boundary layer aerodynamic effects as described in the proposed embodiments can have a beneficial impact on the fatigue and extreme loads of the turbine, and thus improve the operations and lifetime of the asset. This can assist in creating enhanced performance modes that focus on loads optimization (LO modes) and improve the power performance of the asset. Load reduction is also a substantial step in the creation of new turbines that meet type-class requirements, meaning that new generations of turbines can be developed that take into account the beneficial load reduction potential of the proposed embodiments. Operators of wind assets can similarly take advantage of the load and vibration reduction benefits, as reduced maintenance equates to increased uptime and revenue.

By modifying the sound/noise generated by the rotor blade, and thus potentially a turbine or a turbine farm overall, a number of strategic opportunities become available. The turbine can be coupled to a controller to modify operational characteristics, such as angles of attack, rotation speed, etc., so that the turbines can thus be run more aggressively so long as a sound threshold is not exceeded. In this example, the controller can include a feedback control circuit that takes sound as measured as a sensor as an input and uses this to control/optimize power generation. The sensor can either be positioned on the turbine itself, or as a microphone at a distance away from the turbine and measurements are relayed back to the turbine.

In another variation, because the noise at certain offending frequencies can be reduced, the turbine can be positioned closer to a human settlement (e.g., in accordance with standards/noise regulations). This is especially helpful if lower frequencies are being attenuated, because lower frequency noise travels farther. In another variation, because the noise at the relevant frequencies can be reduced, the density of a turbine farm can be increased (e.g., so long as the overall noise contribution does not exceed a particular threshold). Accordingly, the serrations and corresponding approaches proposed herein can be useful in a number of different practical scenarios.

In an alternate variation, instead of, or in addition to negating noise, the plurality of projections and troughs instead are adapted to produce or modify noise such that it is generated in a desired frequency band. In this variation, the plurality of projections and troughs have features that generate noise in the desired frequency band that is based at least on a frequency band that is repulsive to various types of animals, such as birds, bats, fish, insects (e.g., a high frequency band that is outside of the realm of human hearing), given a designated local wind speed. To generate the sound (e.g., noise) in the desired frequency band, a portion of the structure or the blade itself can include one or more apertures, such as a hole. A number of apertures can operate together to create noise at a number of different frequencies (e.g., similar to a “Swiss cheese”) based on their configuration, and the apertures, for example, can be in different sizes, such as 0.5 mm, 0.6 mm, 0.7 mm, etc.

The aperture(s) operates by causing a pressure difference between the suction side and the pressure side, generating a whistling sound based on the size, for example, through a resonation at a frequency from the pressure difference. The aperture can be a straight circular hole or can be an oblong hole depending on the desired sound output. The sizing of the aperture may be based on a function of the local wind speed and the desired sound frequency output.

The size of the aperture(s) can be adjusted based on the desired generated noise. The one or more apertures can be positioned on various different portions depending on where strikes occur or are projected to occur, and for example, can be positioned on a distal portion near the tip of a blade or rotor as this area encounters the highest airspeed (and thus is most dangerous in terms of impact force for the animals—even if there is no direct impact, animals may be wounded by rapid pressure changes/turbulence). In some embodiments, the size and/or geometry of the aperture(s) can be dynamically determined and re-sized during operation through changing an aperture size or geometry. For example, a small aperture motor can be used to change the aperture size, expanding or shrinking the aperture as needed. One motor can be coupled to each aperture, or in some embodiments, a set of common motors can be used across multiple apertures. Similarly, if projections can have variable geometry changed using motors, similarly, the motor to drive projection changes can also be used to change aperture sizes. In a specific embodiment, each projection portion region has a corresponding set of one or more motors that controls operation for that particular region (either manually set or in combination with a sensor measuring operational characteristics, such as local wind speed, blade geometry/profile, or boundary conditions).

The aperture(s), from a retrofit or attachment perspective can be embedded into projections such that the projections interoperate together to provide both a beneficial sound (animal repelling noise in higher frequencies) and a noise reduction across human-audible sound ranges through destructive interference or changes in operational aerodynamic profiles. The combination approach is useful as a single retrofit/profile modification and serves both functions in relation to changing the overall sound/noise profile emitted by the devices in operation.

Accordingly, in this approach, the apertures operate to generate the sound to deter/repel animals. The aperture(s), if positioned on the distal portions of the rotor or blade, create a “clearance zone” established in a ring during operation of the turbine, and this helps create a “noisy” region for animals to identify and to avoid (e.g., this would not be a good “roosting site”), which helps mitigate some potential environmental challenges related to practical operation (e.g., reducing bat mortality may be important for farmers).

In some embodiments, a particular species of bat, as example, may be desirable to protect. As different bat species are known to use different frequency bands, and fly at different wind speeds, the designated atmospheric wind speed determined through turbine SCADA data and the associated effective local wind speed on the turbine blade (determined through RPM via the controller) can be used to inform the exact geometry of the aperture, and the projections or troughs are adapted to match these criteria to target a desired frequency band during manufacturing. In an alternate embodiment, the projections or troughs are adapted during operation through adaptive control based on a dynamically or periodically determined local wind speed, and/or other operational parameters of a turbine. As different portions of a blade or airfoil can experience different local wind speeds, the projections or troughs can have different geometries for different regions, either discretely or continuously such that the same or approximately the same frequency of noise can be specifically generated. In an alternate embodiment, the geometry used to generate a specific frequency may be an aperture, hole, slit, filet, recess, bevel or the like.

In an embodiment, the geometry of the alternating projections and troughs are such that two adjacent troughs are positioned relative to each other with different axial distances in the chord-wise direction, such that each may initiate a sound wave of a known frequency range that, when interacting with the proximate sound wave created by its neighboring trough, cancels itself out deconstructivity (e.g., with destructive interference).

To target a particular frequency, for example, serrations of different lengths can be established across a span of an airfoil blade, and the different lengths can be established based on portions of the blade or based on a continuous changing profile of the blade.

The portions-based approach can be used in situations to contain manufacturing complexity as it may be more challenging to produce unique serrations for the entire span of the blade. Accordingly, in this variation, instead of continuously changing the lengths, the approach may include establishing a plurality (e.g., 2, 3, 4, 5, 6, 7, 8, 9, 10) lengths that will be effective in respect of various sections of the blade instead.

Wind tunnel testing was utilized to experiment with an example prototype airfoil, exhibiting noise reduction across multiple frequencies with a significant reduction at a particular frequency range in the audible frequency spectrum.

According to another embodiment, the axial spacing (e.g., exact axial spacing or approximate axial spacing) between two adjacent troughs is governed by the input parameters of the speed of sound (Us) given the operating temperature, the boundary displacement thickness (δBL) and the total local wind speed (UL). As noted above, the peak frequency of trailing edge noise is a function of wind speed and chord length.

In contrast with Chong, the proposed approach herein is directed to a different geometry and chordal relationship. In the proposed approach, the chordal relationship d′ is adapted to be based at least on the speed of sound, a boundary displacement thickness, and a total local wind speed.

In a particular non-limiting example, in an embodiment proposed herein, the localized spatially-dependant chordal relationship d′ between two troughs is given by the following formula:

$${d}^{′} = \frac{{U}_{s} {δ}_{BL}}{0.14 {U}_{L}} ,$$

where d=distance between troughs, Us=Speed of sound, δ_{BL}=Boundary displacement thickness, and U_{L}=Total local wind speed.

In the proposed approach of this embodiment, the chordal relationship d′ is based on specific input parameters of the speed of sound (Us) given the operating temperature, the boundary displacement thickness (δBL) and the total local wind speed (UL). As differing regions of the structure (e.g., a blade) may encounter different local wind speeds, as described further, variations are possible where different regions of the structure have different d′, and these regions can be established on a discrete basis or approximated on a continuous basis along the structure (e.g., having a value of d′ determined for each serration based on the prevailing local wind speed at the particular serration).

In an alternate variation, instead of, or in addition to negating noise, the plurality of projections and troughs instead are adapted to increase the aerodynamic performance of the airfoil they are applied to. The aerodynamic performance is measured as a ratio of lift over drag for the airfoil and by the quality of the wake behind the airfoil.

In an embodiment, the airfoil is a rotor blade for a wind turbine. The structures described herein are provided with a view to reducing scattering of turbulent fluctuations within the boundary layer at the trailing edge of the rotor blade. As a result, rotor blade projections and troughs for a wind turbine are provided which decrease the noise emissions and/or increase the efficiency of the wind turbine as a whole through their application and use.

In an embodiment, the structures described herein may increase the efficiency of the wind turbine by allowing for a greater rotor RPM to be achieved, given a limiting noise sound power level. Such a use is desirable to an operator of a wind turbine, as more power may be generated without exceeding noise guidelines in the surrounding area.

According to an aspect, the rotor blade alternating projections and troughs are applied in the range of 40-96% of the rotor blade, where the root of the rotor blade represents 0% and the blade tip represents 100%.

In another embodiment, the airfoil is a rotor for a drone. The structures described herein are modular and adaptable in nature, such that any airfoil and its related input parameters impact its geometry and use.

According to an aspect, the alternating projections and troughs are applied in the range of 0-99% of the rotor, where the root of the rotor represents 0% and the tip represents 100%.

According to another aspect, the rotor blade alternating projections and troughs may alternate in length and width and be non-uniform in how they are dispersed.

According to yet another aspect, the rotor blade alternating projections and troughs generally decrease in length, width and relative distance to each other in relation to positioning towards the blade tip.

According to still another aspect, the alternating projections and troughs contain geometrical chamfers and splines so as not to interfere with the path of least resistance of the air as the air flow moves from the leading edge to the trailing edge of an airfoil.

According to still yet another aspect, the alternating projections and troughs may be composed of biologically or non-biologically based materials.

According to still yet another aspect, their method of manufacture may be through injection molding, 3D printing, or laser or water jet cutting.

According to another embodiment of this invention, the alternating projections and troughs may be flexible or rigid and/or have a curvilinear or linear architecture.

According to another embodiment of this invention, the leading edge of the attachment surface of the alternating projections and troughs may have a curvilinear or linear architecture.

According to another embodiment of this invention, the alternating projections and troughs and the aerodynamic body of the rotor blade may be a unitary structure.

According to an aspect, the alternating projections and troughs and the aerodynamic body of the rotor blade may be two (2) or more pieces connected to each other by way of adhesive.

According to an aspect, the alternating projections and troughs and the aerodynamic body of the rotor blade may be two (2) or more pieces connected to each other by way of a clamp or multi-faced structure that adheres a base section of alternating projections and troughs to a suction side and/or a pressure side of an airfoil.

According to another embodiment of this invention, various methods of application of the alternating projections and troughs to the aerodynamic rotor blade body may be carried out and may be applied to an existing wind turbine and/or a wind turbine during its manufacture.

According to another embodiment, the structure can be applied to a non-limiting example airfoil, not dependent on the aerodynamic design thereof. A similar type of noise emission can also come from the trailing edge of a rotor on a drone, where a stereotypical ‘buzz’ can be heard from people in the nearby vicinity. For drone operators, whether they be civilian or military in nature, it would be desirable for drone operation to occur with reduced noise proliferation.

Approaches proposed herein can be used in improving the viability of green technologies, such as renewable energy structures and retrofits thereof. In particular, the technologies are adapted to modify or otherwise transform operational aspects, for example, to improve efficiency and/or reduce deleterious effects.

While renewable energy projects are desirable as a technological solution towards challenges faced in relation to the sustainability of the future in view of environmental and climate objectives and goals, the adoption thereof of these technologies is still in the early stages of development and refinements are helpful in increasing the speed of adoption relative to other forms of energy production.

Accordingly, approaches are proposed using innovative approaches that can be based upon investigations of biomimicry and their related aerodynamics.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a side elevation view of a horizontal axis wind turbine according to the prior art.

FIG. 2 is a side perspective view of one of the blades in the horizontal axis wind turbine shown in FIG. 1.

FIG. 3A is a front view of the blade of FIG. 1 and a structure retrofitted onto the blade, according to some embodiments.

FIG. 3B is an enlarged front view of the structure retrofitted onto the blade as shown in FIG. 3A, according to some embodiments.

FIG. 3C is a front view of the blade of FIG. 1 and an alternate structure retrofitted onto the blade, according to some embodiments.

FIG. 3D is an enlarged front view of the alternate structure retrofitted onto the blade as shown in FIG. 3C, according to some embodiments.

FIG. 4 is a side perspective view of a section of the structure shown in FIG. 3A, according to some embodiments.

FIG. 5 is a front view of the section of the structure shown in FIG. 4, according to some embodiments.

FIG. 6 is a two-dimensional graph showing a sound level produced by a blade having the structure shown in FIG. 3A and a blade not having the structure shown in FIG. 3A as a function of frequency.

FIG. 7A is a side perspective view of the section of the structure shown in FIG. 5, according to some embodiments.

FIG. 7B is a side view of one of the projections contained in the section of the structure shown in FIG. 7A, according to some embodiments.

FIG. 7C is a top-down perspective view of a portion of the section of the structure shown in FIG. 5, according to some embodiments.

FIG. 7D illustrates a cut-away perspective view of an example trough geometry.

FIGS. 8A, 8B and 8C are side views of the section shown in FIG. 5 coupled to a trailing edge of the blade shown in FIG. 2 at the pressure side of the blade, the suction side of the blade, and on both the pressure and suction sides of the blade, respectively.

FIG. 8D is a side view of the section shown in FIG. 5 coupled to a trailing edge of the blade shown in FIG. 2, whereby the base section and structure defining the primary and secondary troughs may be at a relative angle to each other.

FIG. 9 is a view of a noise generation variant for deterrence, according to some embodiments.

FIG. 10 is an example airfoil/airfoil shape, for reference.

### DETAILED DESCRIPTION

As described herein in various embodiments, approaches are presented that are adapted to improve the adoption and viability of different types of airfoil type structures, through the modification of noise generated by the airfoil structures as they move through a fluid, such as air or water.

In particular, a specific structural approach is proposed that utilizes geometric features to modify various aspects of aerodynamics of the fluid as it interacts with the structure, the geometric features utilized to reduce noise at a target frequency, subsequently impacting the aero-acoustics in desirable ways. For example, undesirable noise at a target frequency that is in the human hearing spectrum can be reduced, while alternatively or contemporaneously, in various variant embodiments, desirable noise at a target frequency can be generated (e.g., to repel animals so that they are more likely to avoid the airfoil or control surface and thus may avoid being inadvertently impacted by the airfoil). Variations are also proposed whereby modifications to an existing airfoil or a new airfoil structure is proposed that can be used, for example, as a rotor of a propeller, a turbine blade, an aerocraft wing (e.g., airplane, drone).

As described herein, a number of different variations are possible using different sectioned geometries, different widths between projections, and different trough/projection geometries. These geometries are adapted based on the desired noise frequency modification, and in some cases, can be conducted during an initial manufacturing stage, or added on through a retrofit of an existing airfoil (e.g., a blade).

The geometries, in particular, are coupled to a trailing edge of the airfoil, and Applicants have been experimenting with and proposing various approaches for reducing noise in respect of a trailing edge. For example, in U.S. Pat. No. 10,690,110B2 (published also as US20170276117A1 to Church, (and corresponding Canadian, European, and PCT applications), in 2014/2015, Applicants had proposed an alternating projection approach having two sets of projections whose lengths were adapted to establish destructive interference in respect of or based at least on a target sound frequency. These projections, depending on the embodiment, could extend from the trailing edge or the leading edge.

A number of variations were presented, including rigid projections having different types of profiles, such as bulbous projections, etc. In this approach, the neighboring projections had varied lengths based on wavelengths of the sound waves produced at varying regions of the rotor blade, which were based on the velocity of a fluid being interacted with at a various point. As described in the present description herein, variations and improvements on the earlier approach are proposed.

U.S. Patent Application Publication No. US 2008/0166241 to Herr et al. discloses a means of reducing the noise emissions of a rotor blade during use by employing bristles at the trailing edge of a rotor blade. According to Herr, for reducing trailing edge related noise, shorter bristles achieve better reduction results for lower frequencies, whereas longer bristles tend to be more effective for higher frequencies. Herr explains that a combination of bristles with significantly different outer dimensions in the same region of the blade contributes to a reduction characteristic with a higher efficiency in a broad frequency spectrum. The radiated noise from a rotor blade is loudest for an incident pressure wave that is aligned with the edge of the rotor blade and traveling normal to that edge. As the pressure wave passes over the edge, it encounters a sudden change in acoustic impedance, resulting in the scattering of noise. The bristles can be viewed as a means of distributing this sudden change in impedance over a finite distance, thereby reducing the strength of the scattering process.

However in Herr, the straight serrations also resulted in a significant increase in noise at high frequencies (>2000 Hz). The use of straight serrations requires careful placement and a careful consideration of widths and lengths in order to achieve a desired effect. In addition, turbulent inflow noise may contribute to the noise spectrum of a wind turbine at low frequencies. Thus, in Herr, one must manage both the incoming and the outgoing air flows in order to achieve a desired effect, and this is technically challenging.

In order to increase the effectiveness of serrations, some other approaches have applied structures between serration teeth to reduce noise. For example, PCT Application EP2016/058428 describes a serration with porous material between two teeth of said serration.

Others have claimed to take inspiration from the wing of an owl, appearing to do so without fully understanding the mechanism behind its action. PCT Application GB2020/051178 to Chong et al. describes the use of a series of alternating rigid projections, where distances from troughs to troughs and troughs to peaks are taken together in the formation of the serration geometry. In U.S. Patent Application Publication No. US20220074383A1 to Chong et al., an approach is proposed for add-on components of an airfoil using either a slitted formation and a double-rooted trailing edge serration.

The “double rooted” structure proposed in Chong includes two axial heights, noted as h′ and h″ in FIG. 1A of Chong, and a specific geometrical relation, namely, that

$${h}^{′} = \frac{\hat{c} \cdot {U}_{∞} \cdot κ}{2 {f}_{peak}} , ,$$

where Ĉ is a convection velocity factor whose values lie from 0.4 to 0.8, and the relation between h′ and h″ to satisfy the empirical factor:

$$κ = {( \frac{{h}^{″}}{{h}^{′}} )}^{0.4} .$$

U_{∞} is the freestream velocity in m/s.

As noted in Chong at para. 0098, the proposed structure of Chong must have a Strouhal number condition fulfilled and the specific empirical factor accounts for the possible non-equal value between the h′ and h″ in the frequency scaling.

In Chong, at para. 0100, in particular, h′ is adjusted accordingly to affect, for example, a maximum noise reduction peak.

An improved approach and structure is proposed herein that uses alternating projections and troughs, which, in operation, have specially adapted geometries that are adapted for noise modification (e.g., noise reduction).

The geometries that can be established can have axial spacing, distances between troughs, among others. The alternating projections and troughs can be provided in the form of a double-peaked serration, where a first peak and a second peak can have different heights. There can be a “primary” trough established between discrete serrations, and a “secondary trough” established between the first and the second peak (e.g., at the midpoint or any another point between the first and the second peak). Each of these peaks and their corresponding geometries can be adapted to provide an improved serration that causes noise modification in respect of a target frequency or a target band of frequencies (which may also be impacted by the wind speed at a particular chordal section of a turbine).

The serrations carrying the projections and their troughs can be retrofit or otherwise attached onto the trailing edge of a body traversing the fluid, such as a wind turbine blade. The specific geometry can be pre-defined based on expected wind speeds, sound frequencies to be modified, etc. In some embodiments, the geometry can have a limited passive ability to shift in shape, for example, through selection of temperature sensitive materials. This is useful where the temperature impacts the wind speeds and/or frequencies of interest.

By modifying the sound/noise generated by the rotor blade, and thus potentially a turbine or a turbine farm overall, a number of strategic opportunities become available. The turbine can be coupled to a controller to modify operational characteristics, such as angles of attack, rotation speed, etc., so that the turbines can thus be run more aggressively so long as a sound threshold is not exceeded. In this example, the controller can include a feedback control circuit that takes sound as measured as a sensor as an input, and uses this to control/optimize power generation. The sensor can either be positioned on the turbine itself, or as a microphone at a distance away from the turbine and measurements are relayed back to the turbine.

In another variation, because the noise at certain offending frequencies can be reduced, the turbine can be positioned closer to a human settlement (e.g., in accordance with standards/noise regulations). This is especially helpful if lower frequencies are being attenuated, because lower frequency noise travels farther. In another variation, because the noise at the relevant frequencies can be reduced, the density of a turbine farm can be increased (e.g., so long as the overall noise contribution does not exceed a particular threshold). Accordingly, the serrations and corresponding approaches proposed herein can be useful in a number of different practical scenarios.

In a practical experiment, a modern commercial multi-megawatt wind turbine was outfitted with six (6) serration sections 200A, 200B, 200C, 200D, 200E, 200F, according to an embodiment as described herein and compared to the same turbine with the triangular serrations in accordance with an alternate approach. The geometry of section 200A conferred a d′ of 335 mm, d″ 12 mm, w′ of 33 mm and w″ of 33 mm. The geometry of section 200B conferred a d′ of 305 mm, d″ 11 mm, w′ of 30 mm and w″ of 30 mm. The geometry of section 200C conferred a d′ of 260 mm, d″ 10 mm, w′ of 24 mm and w″ of 24 mm. The geometry of section 200D conferred a d′ of 225 mm, d″ 8 mm, w′ of 20 mm and w″ of 20 mm. The geometry of section 200E conferred a d′ of 220 mm, d″ 7 mm, w′ of 18 mm and w″ of 18 mm. The geometry of section 200F conferred a d′ of 150 mm, d″ 5 mm, w′ of 10 mm and w″ of 10 mm.

Variations of this geometry are also possible, such as the following: the geometry of section 200A conferred a d′ of 350 mm, d″ 13 mm, w′ of 15 mm and w′ of 15 mm. The geometry of section 200B conferred a d′ of 325 mm, d″ 12 mm, w′ of 13 mm and w″ of 13 mm. The geometry of section 200C conferred a d′ of 300 mm, d″ 10 mm, w′ of 11 mm and w″ of 11 mm. The geometry of section 200D conferred a d′ of 275 mm, d″ 8 mm, w′ of 8 mm and w″ of 8 mm. The geometry of section 200E conferred a d′ of 225 mm, d″ 7 mm, w′ of 7 mm and w″ of 7 mm. The geometry of section 200F conferred a d′ of 175 mm, d″ 5 mm, w′ of 5 mm and w″ of 5 mm. Such a variation would set to target increased noise reduction and production at the expense of decrease practical considerations such as increased material, handling and production vulnerabilities and loads, though either is possible based on expertise in turbine operations, manufacturing and installation.

These geometries are shown in example, and provided as example, non-limiting illustrative embodiments.

The results of such testing of the proposed embodiment reduced to practice indicates a strong reduction in the apparent sound power levels (SPL), when analyzed to IEC standards, in reference to TABLE 1. The delta in the table is in reference to the difference (improvement), and is provided as an absolute value.

The experiment was conducted for a wind turbine encountering a wind speed as measured at the hub of 8 m/s, but other variations are possible, such as a speed of 4 m/s, 10 m/s, etc. The wind speed as measured at the hub is a useful notation because it can be a proxy for where maximum load occurs on a wind turbine.

TABLE 1

| Hub 8 m/s | |
|---|---|
| f | delta noise reduction |
| Hz | dB |
| 10 | 3.8 |
| 12.5 | 3.5 |
| 16 | 3.7 |
| 20 | 3.1 |
| 25 | 3.4 |
| 31.5 | 3.2 |
| 40 | 2.9 |
| 58 | 2.8 |
| 63 | 3.1 |
| 80 | 3.1 |
| 108 | 2.6 |
| 125 | 1.9 |
| 160 | 4.1 |
| 200 | 3.4 |
| 250 | 3.4 |
| 315 | 3.7 |
| 408 | 2.8 |
| 500 | 2.7 |
| 630 | 2.4 |
| 800 | 1.3 |
| 1000 | 0.4 |
| 1250 | 0.3 |
| 1600 | 1.3 |
| 2000 | 1.7 |

As low frequencies travel further in the atmosphere than high frequencies, attention is paid to the frequency range below 2000 Hz, which is deemed to be the most audible. As example, a frequency band of 630 Hz will travel an order-of-magnitude further in the atmosphere than one at 800 Hz. As such, a lower frequency band of 630 Hz carries an importance that is an order-of-magnitude more important in terms of audibility than an adjacent frequency band of 800 Hz. The geometry of the proposed embodiment is thus tuned to reduce these frequency ranges, with more importance given to progressively lower frequency bands. Tuning is accomplished by modifying d′, whereby an example would be that the secondary trough 231 may be moved closer to a primary trough 233, which would reduce d′. This would serve to target higher frequencies of a reduced wavelength at the same nominal radial position. Tuning can include modifying (e.g., increasing) tip speed ratio through a control update to optimize the torque demand for the controller. Increasing TSR (tip speed ratio) can be conducted through a control update to optimize the torque demand for the controller.

The hallmark ‘whoosh’ sound of a wind turbine is due to low frequency sound waves below 2000 Hz. When the results were analyzed, a change in 2.6 db(A) was found in respect of the maximum broadband noise level for an investigated control mode. This is important as turbines are certified based on a maximum broadband noise level produced and hub height, where 104-107 dB is common. Lowering the maximum broadband noise produced allows for closer turbine sittings to dwellings, allowing for more efficient use of land in wind park development. In use, reducing the maximum broadband noise is beneficial in reducing the risk of generation curtailment and financial penalties associated with over-production of noise emissions.

These are determined through local laws and regulations and often have steep penalties that can see up to 50% or more of energy and revenue loss in extreme circumstances. In addition, wind speeds are generally higher at night, but noise restrictions are also typically higher at night, increasing the importance of reduced noise emissions to negate production and financial penalties.

As shown in TABLE 1, there can be significant improvement at the low frequency sound waves, such as 10 Hz-630 Hz, which is especially helpful as low frequency sound can travel longer distances.

In an embodiment, an airfoil comprising a plurality of alternating projections and troughs along its trailing edge may give alternative aerodynamic and acoustic characteristics to the airfoil. Subsequently, the control system of the turbine with these airfoils may be modified and optimized to take advantage of the new aerodynamic and acoustic characteristics. An advantage of such a system may be improved power production and aerodynamic efficiency and operating parameters. An advantage could also be enhanced noise reduction capabilities given that the previous controller settings have been optimized to operate the turbine to get the lowest acoustic production from the airfoils.

As such, parameters within the turbine controller, sometimes called the Supervisory Control and Data Acquisition (SCADA) system, such as TSR and blade pitch angle tables corresponding to wind speed or rotor thrust may be adjusted in beneficial ways. In some cases, specialized control modes may be developed that take advantage of the aerodynamic and acoustic performance of the airfoils with the plurality of alternating projections and troughs.

As example, an increase in TSR of 0.2 is enabled in the wind speed range of 7-9 m/s, and 0.1 in the wind speed range of 10-11 m/s, all while not increasing the noise production of the turbine. Adjustments in the fine blade pitch table of +0.5 degrees in the wind speed range of 7-11 m/s enable this improvement, without exceeding loading limits. The net benefit is additional power production, brought about by the increase in the lift/drag curve of the rotor blade, in combination with the decrease in noise production.

For example, an example control modification can include a sensor that tracks sound generation/noise from the turbines. This generated sound for either a turbine or an entire turbine farm can then be calculated, either at a point on the turbine itself, in the turbine farm, or at a point away at the turbine (and communicated back). This can be used to control and optimize the operation of the turbines as one of the feedback parameters to control aspects such as speed, blade pitch angle, etc. In an example embodiment, the maximum noise threshold can be determined and parameters can be controlled as negative feedback loops to keep the noise generated below the threshold.

The specific feedback parameters can be sent in the form of control data payload data objects that are processed by an onboard controller that changes operational characteristics of the system through controlling mechanisms such as physical actuators, motors, etc., that physically change the angle of attack or change a generator speed, turbine rotation, etc. These parameters can all impact the total noise generated by the turbine or a turbine farm, as well as the overall power production.

In an aspect of this embodiment, enhanced control parameters can be utilized commercially in the creation of additional power output or reduction of noise emissions. These features can allow an operator to up-rate a turbine, creating a higher nominal rated power production. These features can also be used to create specialized noise, loads or power modes that broaden the commercial applicability of a turbine when considering site specific characteristics like noise offsets from housing or dwellings. This can, as example, allow for more turbines to be placed on a given plot of land during the initial phases of a wind project, if noise reductions are taken into consideration with the proposed embodiments described herein.

For example, because the overall noise of the 10 turbines is reduced by adding the serrations, perhaps 12 turbines can be used in a particular given plot of land. Similarly, a plot of land can be enlarged if the margin distance can be reduced due to the reduced noise.

This can dramatically improve the levelized cost of energy (LCOE) of a project if additional turbines can be fitted to land that is already acquired. In other circumstances, operators of wind turbines may desire to re-power their wind farm with larger blades, higher capacity factor turbines and larger generators. The flexibility of reduced noise output or higher power output makes the possible options of turbine platforms to choose from greater and increases the cost-competitiveness of turbines that are equipped with the devices in accordance with various proposed embodiments herein. These features may be applied to wind turbines that are either onshore or offshore as the case may be.

FIG. 1 is a side elevation view of a horizontal axis wind turbine 10. Wind turbine 10 includes a tower 20 supported by and extending from a surface S, such as a ground surface. Supported by tower 20, in turn, is a nacelle 30 extending horizontally. A hub with a spinner 40 is rotatably mounted at a front end of nacelle 30 and is rotatable with respect to nacelle 30 about a rotation axis R. Spinner 40 receives and supports multiple horizontal-axis rotor blades 100 that each extend outwardly from spinner 40. Rotor blades 100 catch incident wind Wi flowing towards the wind turbine 10 causing the blades 100 to rotate. Since the blades 100 are supported by spinner 40, when rotor blades 100 rotates, spinner 30 will also rotate about rotation axis R. The rotational motion of spinner S can be converted into usable electrical or mechanical power. In this sense, rotor blades 100 are each structures adapted to traverse a fluid environment, where the fluid in this embodiment is ambient air. Nacelle 30 may be rotatably mounted to tower 20 such that nacelle 30 can rotate about a substantially vertical axis (not shown) with respect to tower 20, thereby enabling rotor blades 100 to adaptively face the direction from which incident wind Wi is approaching wind turbine 10. A nose cone 50 of generally a uniform paraboloidal shape is shown mounted to a front end of spinner 300 to deflect incident wind Wi away from spinner 300.

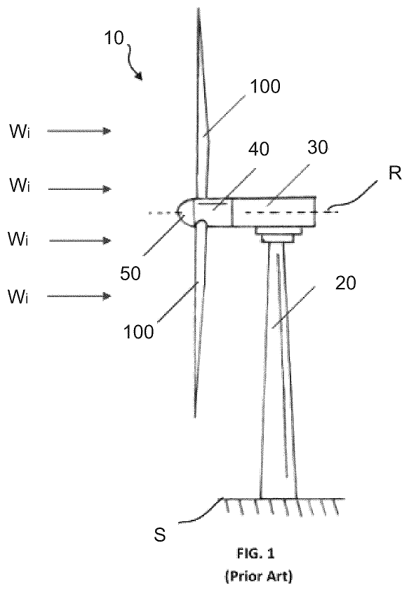

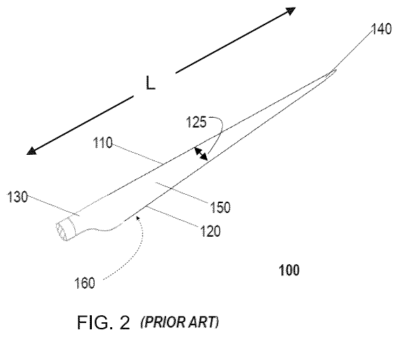

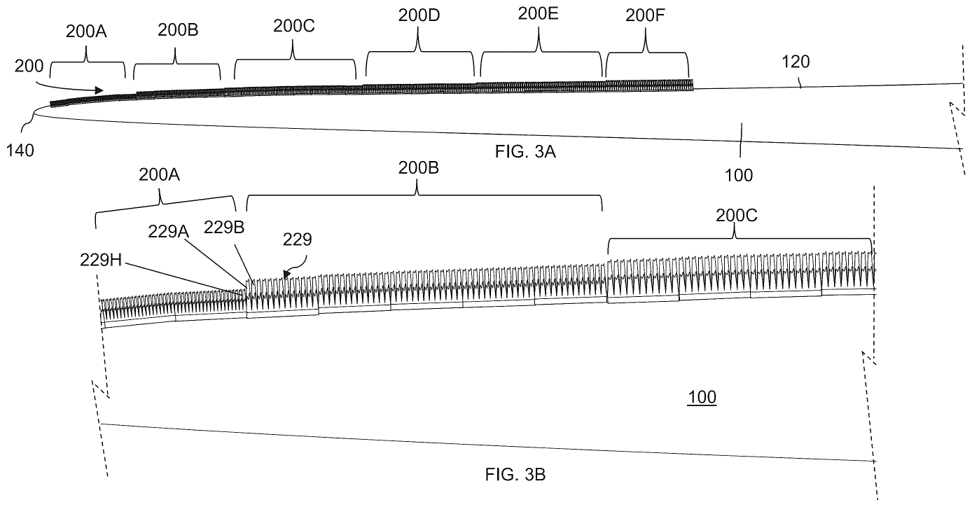

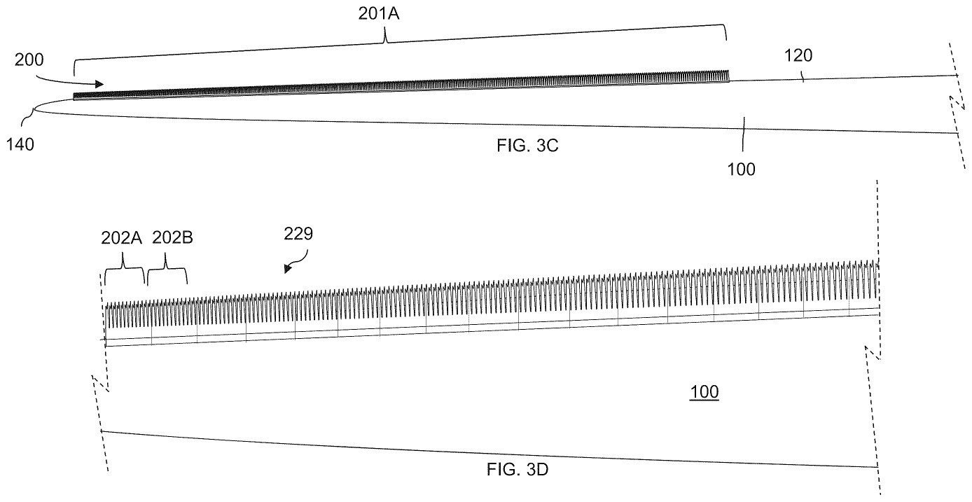

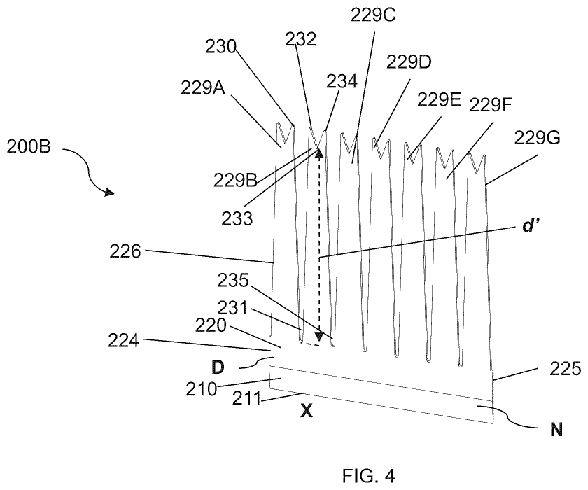

FIG. 2 is a side perspective view of one of the horizontal axis rotor blades 100. Blade 100 includes an elongate body having a length L that extends from a root 130 to a tip 140. The elongate body has a leading edge 110 and a trailing edge 120, where leading edge 110 passes through the air before the trailing edge 120 when rotor blade 100 is in motion. Here, the leading edge 110 and the trailing edge 120 are separated from each other along a chord length 125. The chord length 125 is at a maximum near the root 130 of blade 100 and progressively decreases in size until reaching the tip 140 of the blade 100. A pressure side 150 of the elongate body is shown here, and a suction side 160, shown in dotted lines, is opposite the pressure side 150 of the elongate body of the rotor blade 100. In a current approach, without a structure 200 of alternating projections and troughs (shown in FIGS. 3A-3B), wind moving along the suction side 160 and pressure side 150 of the elongate body of the rotor blade 100 meet abruptly at a trailing edge 120 creating turbulence and noise. The wind moving along the suction side 160 and the wind moving along the pressure side 150 may have different flow parameters (e.g., flow velocity) and may converge and mix at the trailing edge 120 generating noise. With a structure such as that described in European Patent Application EP2016/058428, the abrupt mixing of air at the trailing edge is reduced somewhat, but with none of the additional benefits of destructive interference to further reduce noise, through the geometry and method described herein.

FIG. 3A is front view of blade 100 and a structure 200 retrofitted onto blade 100 containing a plurality of projections 229 (shown in FIG. 3B). As depicted, structure 200 may be geospatially apportioned into a plurality of sections 200A-200E that each extend along a portion of trailing edge 120 of blade 100. FIG. 3B is an enlarged view of structure 200 retrofitted onto blade 200. As depicted, each of the projections 229 in a given section 200A-200E may be identical in geometry. Further, the geometry of the projections 229 contained in a given section 200A-200E may be different than the geometry of the projections 229 contained in the other sections 200A-200E. For example, as depicted, the geometry of projection 229A in section 200B is different than the geometry of projection 229H in section 200A. It should be understood that the arrangement of sections 200A-200E is only exemplary, and that structure 200 may be arranged to have a different number of sections containing a different number of projections. Although FIGS. 3A-3B illustrate structure 200 being retrofitted onto or coupled to blade 100, it should be understood that structure 200 may be integrally formed with blade 100.

FIG. 3C is front view of blade 100 and a structure 200 retrofitted onto blade 100 containing a plurality of projections 229 (shown in FIG. 3D). As depicted, structure 200 may be geospatially apportioned into a structure 201A continuously increasing in height starting from a tip section 140 that extends along a portion of trailing edge 120 of blade 100. As shown in FIG. 3D, said structure 201A may be broken up into a variety of segments such as 202A-202B, as example, such that each of the projections 229 is progressively altering in height with respect to its neighboring projection. Such a configuration may be beneficial when targeting numerous frequencies of interest, or when maximal noise reduction is desired in place of manufacturing complexity. The manufacturing complexity is higher in such a construction, as each of the segments 202A-202B must be customized to apply to a specific airfoil section along the blade 100. Such a situation may arise if a turbine manufacturer wanted to create a designated ‘low noise’ turbine blade for a specific market.

In this case, it may be desirable to create a series of alternating segments 202A-202B of a plurality of projections 229, as the rotor blade 100 would be customized for such a low-noise market application, as mass-production would be warranted. In such an example, the series of alternating segments 202A-202B could be designed to knockout frequencies in the range of 200 Hz at the proximity closer to the axis of rotation R and the frequencies in the range of 800 Hz at the proximity closer to the blade tip 140. In this case, d′ would be set at 23% of the local chord length in an optimized setup to knock out 200 Hz and 17% of the local chord length in an optimized setup to knockout 800 Hz. Such markets could be repowering in nature, where a power developer wishes to re-use a foundation or tower segment of a turbine, but replace the blades and/or generator, or it could be region or country specific, such as France or Asia-Pacific.

A number of different sectional approaches are described herein, as the number of sections can depend on operational and configuration factors. An aspect for consideration is that the wind speed encountered at different locations may be different, and different sectional approaches are used to better match wind speed to configuration. However, due to practical limitations, the sectional approach may be ultimately broken into a set of discrete regions, each region having serrations of a configuration for that region. This approach is useful in situations where it is important to be economical in terms of manufacture, for example, in mass-produced sectional retrofits. In an alternate variant, instead of sections, each and every serration is matched to the wind speed encountered by that particular serration. This approach can be used, for example, in practical situations where accuracy is very important despite the additional cost of manufacture. This can be additionally useful in situations where highly controlled manufacturing techniques are utilized, such as additive printing approaches (3D-printing), and can used to prepare bespoke or customized serration configurations for a particular practical usage implementation. Different approaches can be used for different levels of required noise modification (e.g., turbines in rural areas as opposed to turbines near residential areas).

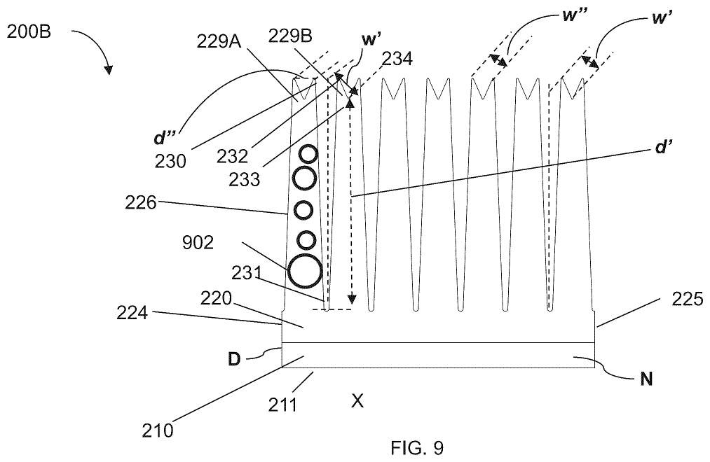

FIG. 4 is a side perspective view of section 200B of structure 200. Section 200B may contain a base section 220 which is chamfered at an end portion 210 such that the edge 211 of the base section 220 meets flush with the surface X of the trailing edge 120 of the blade 100 (shown in greater detail in FIGS. 9A-9B). This arrangement may ensure that there is as little interference as possible with the natural flow of the air coming from the surface X over the base section 220. As illustrated, section 200B may have a near end N and a distal end D. Structure 200 may be retrofitted or integrated onto blade 100 such that distal end D is in closer proximity to tip 140 of blade 100 than near end N. Chamfering is an additional approach that can be utilized to further improve noise reduction performance. The chamfered design is another contemplated embodiment.

Through the provisioning of the serrations, instead of all the air flowing under the airfoil and then mixing with all the air flowing over the airfoil at the same chordwise location, the serrations spread out the mixing over a larger area, and prevent the turbulent nature of the mixing to occur all at once in one location. Some of the air will mix at the troughs. If these troughs are separated by a distance equal to half a sound wavelength, the noise at that wavelength will experience destructive interference, and be quieter.

As illustrated in FIGS. 3A-3B, multiple sections 200A-200E of structure 200 can be aligned along the trailing edge of blade 100. FIG. 3B is an enlarged sectional view of a region of FIG. 3A. Each section 200A-200E may be coupled to an adjacent section 200A-200E by coupling a side interface 225 located at distal end D of a given section 200A-200E with a side interface 224 located at a near end N of an adjacent section 200A-200E (not shown, see FIG. 4). In some embodiments, the side interface 225 (see FIG. 4) of a given section 200A-200E may be geometrically configured to mate or nest together with the side interface 224 of an adjacent section 200A-200E. In some embodiments, side interface 225 of a given section 200A-200E may have an equal but opposite geometry to side interface 224 of an adjacent section 200A-200E.

As depicted, section 200B of structure 200 contains a plurality of projections 229A-229E that extend parallel to chord length 125 when structure 200 is retrofitted onto blade 100. For simplicity purposes, the construction of projections 229A-229F will be explained in relation to projection 229B. However, it should be understood that each of the projections 229A-229F may be of a same construction. As depicted, projection 229B may have two or more peaks 232, 234. A primary trough 231 may be defined between projections 229A, 229B and a secondary trough 233 may be defined between the two or more peaks 232, 234. There is no specific number of troughs needed for the serration to work. However, the width of the serrations scales with their length, which is proportional to the chord length. Generally, the shorter the chord length, the more troughs.

Without structure 200, air moving along the suction side 160 and air moving along the pressure side 150 could converge and mix abruptly at a chordwise location along the trailing edge 120 of blade 100, creating undesirable turbulence and noise. However, when structure 200 is retrofitted onto blade 100, structure 200 may cause at least some of the air moving along the suction side 160 and at least some of the air moving along the pressure side 150 to mix at the primary and secondary troughs 231, 233 of projection 229B. In other words, structure 200 causes some air from the suction side 160 and some air from the pressure side 150 to mix at primary and secondary troughs 231, 233 rather than at the trailing edge 120 of the blade 100. The mixing of the air can create noise.

As described above, the primary and secondary troughs 231, 233 define two regions where air moving along the suction side 160 and air moving along the pressure side 150 may mix. The air moving along the suction side 160 may have a different flow velocity than the air moving along the pressure side 150. When the airflows interact at primary or secondary troughs 231, 233, it may result in flow mixing and sound proliferation. In order to reduce an amount of sound generated by primary and second troughs 231, 233, structure 200 may be geometrically constrained to maintain a certain positioning of primary trough 231 relative to secondary trough 233. Specifically, a lowest point of primary trough 231 may be spaced apart from a lowest point of secondary trough 233 by a distance d′ to reduce sound proliferation. The initiation point of these two flow interactions (i.e., at primary and secondary troughs 231, 233) is critical to the initiation of a sound wave and occurs at the minima of the troughs 231, 232. When a sound wave is formed at a primary trough 231, its relational dependency with another sound wave formed at secondary trough 233 at a specific spatially-determined distance d′ is important in that the interaction between the two sound waves produces a reduced sound power level. To be precise by way of example, an energy maxima within a sound wave coming from primary trough 231 will interact with an energy minima coming from a secondary trough 233 to nullify the two sound waves.

In some embodiments, each of the projections 229A-229F in a given section 200B may have a height relative to the edge 211 of the base 211 that is the same as the height of other projections 229A-229F in the given section 200B. In other embodiments, one or more of the projections 229A-229F in a given section 200B may have a height relative to the edge 211 of the base 210 that is different than the height of the other projections 229A-229F in the given section 200B.

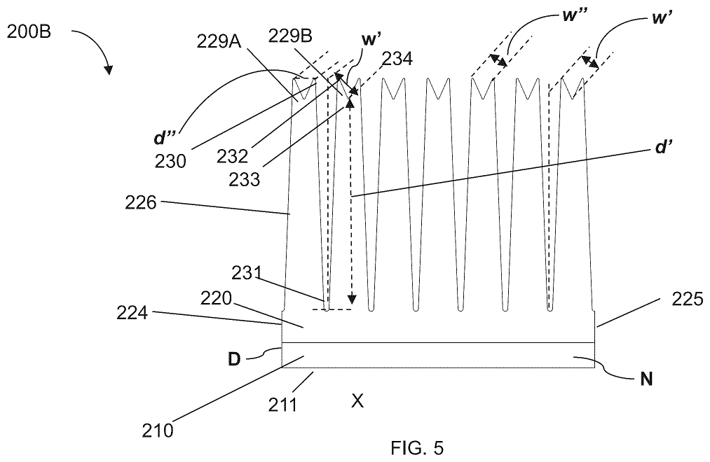

FIG. 5 is a front perspective view of section 200B of structure 200. As depicted, the height of first peak 232 relative to the edge 211 of the base section 220 may be different than the height of second peak 234 in projection 229B. For a specific serration, there can be a first peak 232, and a second peak 234, and these may have a smaller trough 233 between the two peaks as well as a larger trough 231 between individual serrations.

Different lengths of serrations may be possible. For example, it is believed that with “standard” serrations, longer lengths reduce noise at low angles of attack. The longer the serration, the higher the cost and chance of damage. In a specific embodiment, 232 and 234 have different lengths. As example, 232 has a length of 30 cm while 234 has a length of 31 cm. This changes the local position of eddy formation and helps to reduce its impact to the wind farm.

Further, the second peak 230 of projection 229A may have a height relative to the edge 211 of the base section 220 that is different than the height of the first peak 232 of the projection 229B relative to the edge 211. As depicted, the second peak 230 of the projection 229A may be shorter than the first peak 232 of the projection 229B by a distance d″. As illustrated, the lowest point of primary trough 231 and the lowest point of a secondary trough 233 are separated by a distance d′. Since distance d′ is determined based on the lowest point of primary trough 231 and the lowest point of a secondary trough 233, distance d′ may be determined without consideration of a highest point of the two or more adjacent peaks 232, 234. As mentioned previously, maintaining a distance d′ between the lowest point of primary trough 231 and the lowest point of a secondary trough 233 is critical for reducing the amount of sound generated by primary and second troughs 231, 233.

Distance d′ may be determined as a relation between at least a speed of sound, a boundary layer displacement thickness, and a total local wind speed. d′ can be an approximate number and noise cancellation at the most dominant frequency is conducted. While there may be some non-idealities, there can be some inaccuracy in the value of d′, however, there may be some reduction in noise-modification benefits at the target frequency. Given the non-idealities, while the relation can be utilized for establishing the geometric configuration, there is some tolerance for deviation. For example, although neighboring frequency values may be affected, there is still a limited benefit, even if manufacturing tolerances have led to a significant deviation. As an example, values such as d′ may vary from +/−1%, 2%, 3%, 4%, 5%, 6%, 7%, 8%, 9%, 10%, 11%, 12%, 13%, 14%, 15%, and any range continuously in between, etc. In some embodiments, distance d′ between a primary and secondary trough may be determined based on the following formula:

$${d}^{′} = \frac{{U}_{s} {\partial }_{BL}}{0.14 {U}_{L}} \qquad ( 1 )$$

An example calculation is given below:

$${d}^{′} = [ ( 343 m / s ) ( 0.0 \; 15 m ) / ( 0.14 ) ( 57 m / s ) ]$$

$${d}^{′} = 0.645 m$$

Equation 1 may provide the distance d′ between a given primary and an adjacent secondary trough, such as primary and secondary troughs 231, 233, at a specific radial position relative to axis R (i.e., specific position along the length L of blade 100). In equation 1, Uₛ represents the speed of sound that is determined based on an operating temperature; ∂_{BL} represents the boundary layer displacement thickness of blade 100; and U_{L} represents the total wind speed. The speed of sound Uₛ may be determined based on an average operating temperature in the particular region where wind turbine 10 is located, as designated below in Table 2.

TABLE 2

| | Speed of | | Wavelength | | Change in (w) | |
|---|---|---|---|---|---|---|
| Temperature | Sound Uₛ | | (cm) @ | | between it and | |
| (° C.) | (m/s) | | 1 Khz | | the following (w) | |
| 20° C. | 343.216 | m/s | 34.322 | cm | 0.059 | cm |
| 19° C. | 342.63 | m/s | 34.263 | cm | 0.059 | cm |
| 18° C. | 342.043 | m/s | 34.204 | cm | 0.058 | cm |
| 17° C. | 341.455 | m/s | 34.146 | cm | 0.059 | cm |
| 16° C. | 340.866 | m/s | 34.087 | cm | 0.059 | cm |
| 15° C. | 340.276 | m/s | 34.028 | cm | 0.061 | cm |
| 14° C. | 339.685 | m/s | 33.967 | cm | 0.058 | cm |
| 13° C. | 339.093 | m/s | 33.909 | cm | 0.059 | cm |

The boundary layer displacement thickness δ_{BL} may be determined based on the radial position of the primary and secondary trough (i.e., specific position along the length L). In some embodiments, the boundary layer displacement thickness ∂_{BL} may be determined based on the shape of blade 100, chord length 125 which is related to the radial position of the primary and secondary trough, average local flow velocity, which is based on radial position on the blade, control settings and atmospheric incoming wind, and the angle of attack. The relationship is a complex relationship that includes a number of complex differential equations.

Adding the curvature of the airfoil requires the more complex approach for analyzing the boundary layer. The boundary layer δ_{BL} height is estimated at the point local air velocity equals 99% of upstream air velocity U_{∞}.

The pressure gradient along the airfoil is given by

$$\frac{\partial P}{\partial x} ,$$

where P is pressure and x is the chordwise length.

For incompressible flows the pressure gradient is:

$$\frac{\partial P}{\partial x} = - ρ U \frac{\partial {U}_{∞}}{\partial x}$$

The flow is one dimensional and can be governed by conservation of mass and conservation of momentum. Shear stress on the surface is given by τ. When integrating over a control volume, the equation becomes:

$$- {U}_{∞} {\int }_{0}^{{δ}_{BL}} \frac{\partial Pu}{\partial x} dy + {\int }_{0}^{{δ}_{BL}} \frac{\partial {Pu}^{2}}{\partial x} dy = ρ {U}_{∞} \frac{\partial {U}_{∞}}{\partial x} {δ}_{BL} - τ$$

Using Blassius' approach, it is possible to predict an exact solution while the flow is laminar and the pressure gradient is zero. At the stagnation point:

$${δ}_{BL}^{2} \frac{ρ \partial {U}_{∞}}{μ \partial x} = 7.052$$

The shape of the airfoil is approximate with a polynomial of best fit. The equation can have the following form:

$$\frac{{δ}_{BL}}{θ} = {A ( \frac{ρ}{μ} {θ}^{2} \frac{\partial {U}_{∞}}{\partial x} )}^{2} + B ( \frac{ρ}{μ} {θ}^{2} \frac{\partial {U}_{∞}}{\partial x} ) + C$$

With A, B, C as constants and θ being the momentum thickness.

In the turbulent region, the complex shape is approximated with:

$$\frac{u}{{U}_{∞}} = {\frac{y}{δ}}^{( \frac{\frac{{δ}_{BL}}{θ} - 1}{2} )}$$

Certain values should be pre-set depending on relevant experimental data available.

As solving these formulas by hand is labour intensive, numerical method-based software is used. Accordingly, the boundary layer displacement thickness δ_{BL} may be determined by inputting these parameters into an airfoil analysis software such as XFOIL™ which runs a simulation based on these parameters and outputs the boundary layer displacement thickness δ_{BL}. Total wind speed U_{L} may be determined using the upstream wind velocity and the velocity of the rotating blade 100. The velocity of the rotating blade 100 may be calculated at a specific radial position where the given primary and secondary troughs 231, 233 are located (i.e., specific position along the length L). In some embodiments, the total wind speed U_{L} may be determined using the following equation:

$${U}_{L} = \sqrt{{U}_{∞}^{2} + {( \frac{π r ω}{30} )}^{2}} \qquad ( 2 )$$

In Equation 2, U. refers to the upstream wind velocity, r refers to the radial position relative to the root, and w refers to the revolutions per minute of the blade 100. The upstream wind velocity may be determined by the use of an anemometer in association with the turbine.

In some embodiments, distance d′ between a given primary trough and an adjacent secondary trough may vary at different regions of the airfoil.

Specifically, distance d′ between a given primary trough and an adjacent secondary trough may vary depending on the radial position of the primary and secondary trough relative to a root 130 (i.e., along a length L of blade 100).

As previously described, distance d′ may be based on the speed of sound Uₛ given the operating temperature, the boundary displacement thickness δ_{BL} and the total local wind speed U_{L} (see Equations 1 and 2).

These parameters may vary depending on the radial position of the primary and secondary troughs relative to axis R (shown in FIG. 1). The total local wind speed U_{L} may increase in a radial direction relative to axis R (as set forth in Equation 2). In other words, the closer the primary and secondary troughs are to a tip 140 of the blade 100, the greater the total local wind speed U_{L} will be at that point. The chordal length 125 will also decrease in a radial direction relative to axis R.

In other words, the closer the primary and secondary troughs are to a tip 140 of the blade 100, the smaller the chordal length 125 will be at that point. Based on Equations 1 and 2 and the relationships explained above, it can be drawn that distance d′ may decrease towards a tip 140 of the blade 100 and may increase towards a root 130 of the blade.

In an optimal setup, the chordal relationship d′ between a primary and secondary trough may be half the wavelength of the dominant local frequency.

This setup provides the optimal condition for destructive interference of the first and second sound wave. The dominant local frequency at primary and secondary troughs may be specific to the radial position of the primary and secondary troughs.

The dominant local frequency may be dependent on the boundary displacement thickness δ_{BL} which may be different depending on the radial position of the primary and secondary troughs. As the radial position changes, the chord length 125 also changes, and consequently the boundary layer displacement thickness δ_{BL} will change. The larger the boundary displacement thickness δ_{BL}, the lower the dominant frequency. The reverse is also true.

With reference to FIGS. 3A-3B, distance d′ between the primary and secondary troughs contained in a given section 200A-200F may be identical. In some embodiments, distance d′ between the primary and secondary troughs contained in a given section 200A-200F may be different than distance d′ between the primary and secondary troughs contained in each of the other sections 200A-200F. Distance d′ between the primary and secondary troughs contained in a given section 200A-200F may depend on the section's radial position relative to axis R. The radial position of a given section 200A-200F may be based on the average local flow velocity seen for any given section 200A-200F, with the length of the section being a governing factor. As example, to simplify the equation, one might derive an averaged radial position that represents the midpoint of values seen in a given section.

In some embodiments, each section 200A-200F may have one value for the boundary displacement layer thickness δ_{BL}, representing an averaged boundary displacement layer thickness δ_{BL} determined using the median value for radial position of the given section 200A-200F. A non-limiting example is shown at TABLE 3.

TABLE 3

| | | Distance | Boundary Layer |
|---|---|---|---|
| | Portion | from | Displacement |
| | Number | Tip (m) | Thickness (mm) |
| 200A | 1 | 0.5 | 3.8 |
| 200B | 2 | 3.5 | 5.0 |
| 200C | 3 | 6.5 | 5.8 |
| 200D | 4 | 9.5 | 6.6 |
| 200E | 5 | 12.5 | 7.4 |
| 200F | 6 | 15.1 | 8.2 |

Similarly, each section 200A-200F may have an approximated total wind speed U_{L} determined using the radial position at an averaged midpoint of the given section 200A-200F. Distance d′ between the primary troughs and secondary troughs in a given section 200A-200F may be determined based on the approximated boundary displacement layer thickness δ_{BL} and approximated total wind speed U_{L} for the given section.

The number of sections can change, for example, a continuous set of sections, or a discrete number of sections (e.g., 2, 3, 4, 5, 6, 7, 8, 9, 10). A trade-off between complexity, effectiveness, and cost is considered when determining the number of sections. For example, on a 2 MW turbine, with a 45 m blade, there could be a total of 15 meters of serrations. That 15 meters can be broken into 6 discrete sections, each with a length that is approximated to the median of that grouping. Each section faces different wind speeds (e.g., due to radial positioning distally or proximally from the root), and accordingly, each section can use a different serration configuration, because different wind speeds equate to different frequencies to attenuate. The wind speeds can change as a function of radial distance from the root, and this relationship can be linear. Between each section, different values can be used for d′. In an additional embodiment, d″ may also change per section.

As shown in FIG. 3B, distance d′ between primary and secondary troughs may be greatest in section 200F (furthest from tip) and lowest in section 200A (closest to tip). Distance d′ may progressively decrease in size from section 200F to section 200A along sections 200B-200D. As noted, d′ can be established on a sectional basis, or on a continuous or per serration basis depending on the practical installation and operational constraints. The value of d′ can thus shift as a function of a distance from a tip, or as a distance from a root (e.g., how distal or proximal the serration is). The d′ for a particular serration can be based on the wind speed encountered at the midpoint of the serration for example. Other points can be selected (e.g., the near or the far edge of the serration instead).

In another embodiment, distance d′ between a given primary trough and adjacent secondary trough may be based on the specific radial position of a given primary trough and an adjacent secondary trough relative to axis R. This function can be a linear function. In this embodiment, structure 200 may not be segregated into sections 200A-200F and distance d′ between a given primary trough and adjacent secondary trough may be based on the specific boundary displacement layer thickness δ_{BL} and specific total wind speed U_{L} corresponding to the radial position of the primary trough and adjacent secondary trough. Distance d′ may be calculated using equation (1). This in turn would result in a structure 200 that has a distance d′ that progressively decreases in value towards the tip 140. In all cases, the value d′ should be between 5% and 45% of the local chord length 125 using equation (1) or using the median value for radial position of the given section 200A-200F and taking that chord length 125, as example. More specifically, d′ should aim to fall between 10% and 25%, and more preferably 18%-20%. This ensures that no undue aerodynamic loads are placed on the airfoil and the loads on the structure itself are manageable throughout the relevant operating conditions. This range hits the best performance of noise reduction as the local frequencies of interest tend to be created with a wavelength corresponding to these values of d′. Further, given the constraints of increased loads at increased percentages of chord length 125 and reduced performance of smaller percentages of chord length 125, this range has been found to be optimal for a majority of circumstances. Peeling forces must be taken into account, especially if the structure exceeds 25%, adhesive solutions and material choices become limited and expensive. In specific cases when wind turbine blades are longer than 75 meters, the flow velocity at the tip will likely result in loads, such that a desirable value of d′ should be 10%, 11%, 12%, 13%, 14% or 15%.

As shown in FIG. 5, d″ is the difference in height between two peaks, 232 and 234 in this example. d″ alterations lead to one peak being higher than the other, which creates different axial positions for air to mix. For example, d″ can be measured as the height of the left peak 232 subtracted by the height of the right peak 234, with positive values indicating that the left peak 232 is higher, and negative values indicating that the right peak 234 is higher.

The selection of which peak is higher can be determined, for example, based on the fluid direction. For example, if the right side is the part of the blade furthest from the hub, in some embodiments, the right peak is higher, and in some embodiments, the left peak is higher.

As noted, the different axial positions impact eddy flow as there are alternating axial positions for flow. A layman's description of alternating axial positions for flow includes a first peak extending a few millimeters further than a second peak, to give d″.

These impact noise proliferation and impact tonal aspects of noise by shifting sound made from one frequency to another. In particular, it can be desirable to shift lower frequency noise to higher frequency noise as the noise travels less far from the turbine or it attenuates in atmosphere faster than low frequency noise (e.g., shorter wavelength). There are different versions of d″ configurations contemplated.

In first embodiment, each d″ has the same orientation, meaning that the left peak or the right peak is consistently higher than the other. As noted above, this can be directional based on which side is closer to the hub and which is distal from the hub.

In a second embodiment, each d″ may have an opposite orientation, meaning that the serrations alternate between the left and the right peak being higher. For example, in the first embodiment, d″ is always a positive or a negative value. In the second embodiment, d″ alternates between positive and negative values (e.g., left is higher then right is higher, and so on).

d″ values or configurations can be constant across the serrations, or in some embodiments, may be continuously shifting depending on the identified outcome at a particular point along the blade based on the distance from the hub, for example. In another variation, there are separate sections each having a different d″ value or configuration. This variation is easier for manufacture but is less targeted than a continuously varying version for each serration, but both can be useful in improving the noise properties of the turbine blade.

Finally, each section can also have different configurations, and this may be dependent on the type of fluid flow experienced at each section. The value/configuration for d″ can be determined based on a combination of contributing factors from d′, w′, and w″ as each of these may contribute to the overall noise adjusting properties of the serrations. For example, d′, d″, w′, and w″ can be all selected together such that the overall noise modification for the turbine or a turbine farm as a whole matches a desired outcome, recognizing that the selection of d′, d″, w′ and w″ can also have other impacts on lift, drag, weight, or other aerodynamic factors relevant to operation. For example, d″ can be selected or configured in an attempt to shift undesirable sound into frequencies that potentially deter animals.

Referring to FIG. 5, in some embodiments, the radial distance w′ between a primary trough and adjacent secondary trough may be selected and determined based on the distance d′ between the primary trough and the secondary trough.

The radial distance w′ between a primary trough and an adjacent secondary trough may be determined based on the distance d′ and a dominant frequency to be reduced. Varying w′ and w″ (where W″ is a radial distance between a first peak 232 and a second adjacent peak 234) in addition to d′ may have an additional benefit in allowing for more or less projections and troughs per length of blade, allowing for additional noise reduction in a given section of blade that is known for producing more noise (in the case with reduced w′ and w″). As example, if higher frequency bands are desirable to be reduced, additional projections per radial length may be necessary as the wavelengths are of decreased length, and thus an increased w′ and w″ may lead to a beneficial effect.

In some embodiments, the radial distance w′ may be determined using the following equation:

$${w}^{′} = \frac{{d}^{′} \times κ}{\frac{f}{3}} \times 1000 \qquad ( 3 )$$

$$f = \frac{0.07 {U}_{L}}{{δ}_{BL}} \qquad ( 4 )$$

An example equation is given below:

$${w}^{′} = [ ( ( 0.645 m ) ( 0.07 ) / ( 580 Hz / 3 ) ) \times 1000 ]$$

$${w}^{′} = 0.233 m$$

In Equation 3, the distance d′ is multiplied by a constant K. In some embodiments, the optimal value of constant K is 7% or 0.07. However, it should be understood that the value of constant K may be any value between 1%-99% or 0.01 to 0.99. The product is then divided by one third of the dominant frequency in the band, according to harmonic theory. F may represent the dominant frequency at the specific radial position where the primary trough and the adjacent secondary trough are located. The dominant frequency may be determined using Equation 4.

In Equation 4, the factor 0.07 is proposed, but other values may be possible.

The values of total wind velocity U_{L} and boundary layer displacement thickness δ_{BL} in Equation 3 may be the same as the total wind velocity U_{L} and boundary layer displacement thickness δ_{BL} previously determined.

Example values of w′ and w″ are shown for portion

s as shown in FIG. 3A/FIG. 3B. The values for w′, for example, can depend similarly from a portion to portion basis in a discrete stepwise manner, or in another embodiment, can be evaluated for every serration such that every serration is configured on an individual basis.

| | w’ (mm) | w” (mm) |
|---|---|---|
| 200A | 12.0 | 12.0 |
| 200B | 20.7 | 20.7 |
| 200C | 27.0 | 27.0 |
| 200D | 33.7 | 33.7 |
| 200E | 42.6 | 42.6 |
| 200F | 51.1 | 51.1 |

In some embodiments, F may represent the dominant frequency at the specific radial position of a section 200A-200F where the primary trough and the adjacent secondary trough are contained within (i.e., along a length L of blade 100).

The chamfering of end portion 210 may also change along the length L of the blade 100. The chamfering of end portion 210 may change such that the flow may move from a surface X of a trailing edge to a base 220 of the structure 200, over more surface area at a smaller radial position. The chamfer in this case, could be more severe, given the reduction in flow velocity. The flow in this case has a lower velocity and thus may be acted upon to change its vector without transitioning to turbulent flow. By contrast, the chamfer in the case of a further radial section could be less severe, to allow for a reduction in flow vector change, given increased local flow velocity. In addition, the introduction of sinusoidal geometry onto the chamfer maybe included to induce local flow acceleration and the prevention of turbulence and noise at the trailing edge

In some embodiments, the radial distance w″ between the two peaks of a given projection may be 1/10^{th} of the length of d′.

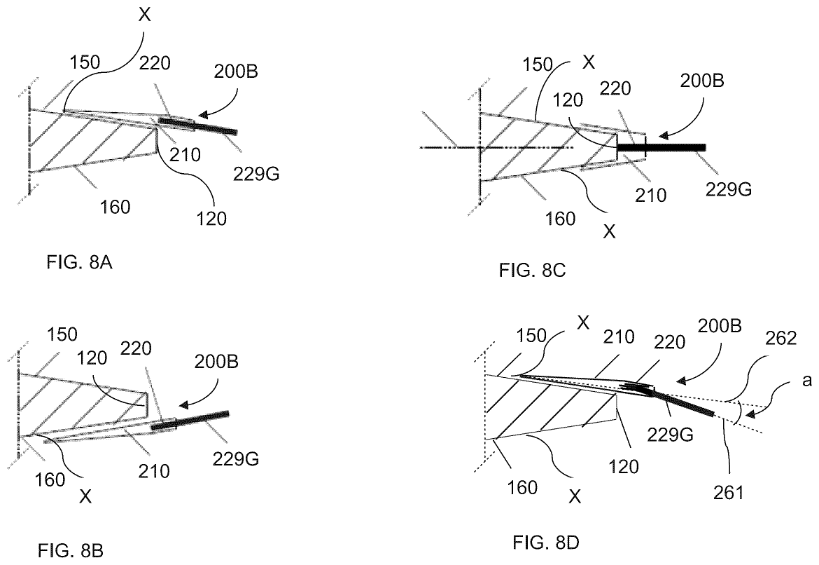

In addition, determining the values of d′, d″, w′ and w″ in practical applications have aerodynamic considerations. The aerodynamic lift over drag performance of an airfoil may be improved through modification of the aforementioned values. Further, in the case of airfoils that are designed to work in a system together, they may be tailored to improve the wake recovery. This is the case for wind turbines, as example, where the current wake propagation is strongly driven by the aerodynamics of the outer portion of the turbine blade, which is the application region for sections 200A-200F, as described previously. For d′ and d″, the effective chord 125 of the blade 100 is altered, which necessarily alters the aerodynamics. Considerations to the degree to which this is changed at specific radial sections along the blade must be made in concert with information on the operational parameters and climactic regime of the turbine, including the desired noise reduction. Changes in w′ and w″ alter the number of aerodynamic elements interacting with the flow and thus, changing the flow pattern. As example, in highly turbulent wind regimes, an increased value of d′ and d″ and a decreased value of w′ and w″ will result in more fluid contact with the structure 200 and cause the flow to become ordered, reducing noise cause by TE-TBL noise. To affect the flow pattern in desirable ways, alterations to the specific geometry of one or more of the peaks 232, 234 may be made. This may include deflecting or rotating one or more of the peaks 232, 234 away from the centerline 262 of the base section 220 or, if the projection 229G is at some angle ‘a’ to this base section 220 as in FIG. 8D, the centerline 261 of the projection 229G. This deflection or rotation induces momentum transfer within the fluid in downstream locations and enables the flow to be re-energized in a quicker manner by the induction of the freestream flow velocity. In cases of increased values of d′ and d″ and decreased values of w′ and w″ the deflection or rotation will be less than in cases where the values of d′ and d″ are decreased and the values of w′ and w″ are increased, relatively. The reason is that, with increased projections 229G, the degree of deflection or rotation is not required as much to achieve the desired effect. Care must be taken such that this is conducted in regions where noise is not a concern, such as in offshore locations, or, if noise is a concern, that the geometry change allows for the operation within permissible noise limitations. In all cases, the main goal is to produce as much aerodynamic uplift as possible within loading limitations, with increased wake recovery, and as little noise emissions or wildlife impact as possible. As such, one may tailor the effects of this invention to the specific attributes they would like, whether that be maximal noise reduction or power performance, given the physical limitations of the turbine structure (FIG. 1). The best configuration for noise reduction will occur when the values of d′ and d″ correspond to the dominant frequency being generated by the airfoil or control surface. The best configuration for power performance will occur when the values of w′ and w″ correspond to mean flow velocity, where the value of w′ and w″ taken together in millimeters is equal to or less the flow velocity in meters per second. With this in mind, a blade designer may take these considerations to heart when designing an airfoil for a specific business jurisdiction, or wind regime. In a recent field campaign, an example section 200E contained d′ at 300 mm, d″ at 10.2 mm, w′ at 31 mm and w″ at 30 mm as part of a series of serration sections 200, providing tangible acoustic benefits of 3 dB reduction over a standard serration.

A reduction in wake is beneficial for installation in a retrofit situation, in that the downstream turbines will benefit from increased wake mixing and increased flow velocities. This is turn improves the revenue generated from a wind farm, as the overall wind speeds impinging on the rotor will be increased. Losses within commercial wind farms from wake effects have been determined to be as high as 20%. In addition, far-field wake effects are now being recorded on wind operators balance sheets, as one offshore wind farm blocks another offshore wind farm. This can happen as far as 100 km away.

Flow patterns can become entrained within the wake and maintain the wake for extended distances. These large-scale blockage effects can impact siting and increase costs for developers. This is a relatively new field within the wind industry, and as such, technologies that can reduce the wake impact in a retrofittable manner are highly desirable.

Reductions in flow speed fluctuation can also have beneficial impacts on turbine fatigue and structural loads, meaning less maintenance is required to operate the assets. Improving the flow velocity so that it is closer to the freestream velocity achieves this and is a desirable outcome.

A reduction in wake is also beneficial for turbine designers and wind farm developers who wish to include as many turbines as possible on a given area of land or sea. Further, aerodynamic and acoustic benefits can be modelled using high, medium and low fidelity computational models to simulate impacts on levelized cost of energy. High fidelity models can be Large Eddy Simulations (LES), as example, where a low fidelity models can be wind resource assessment, siting and energy yield calculations using WaSP. Developers using tools like WaSP can simulate the effect of wake changes in a wind farm and model how technologies can assist in this outcome. This in turn can steer a wind power project from being un-bankable to being bankable and financed.

The technologies discussed herein may also be coupled with other technologies to beneficially improve the performance of a wind turbine and wind farm and improve the downwind rotor wash. These may include, but are not limited to, vortex generators, winglets, leading edge erosion prevention technologies, or devices that improve the lift of the main rotor blades. Wake reduction is achieved through the mechanism of momentum transfer between the freestream flow velocity, which is moving faster and the wake, which is travelling slower. When these two flows interact and nix, momentum transfer occurs, and the net flow velocity is increased, as the wake takes momentum from the freestream flow.

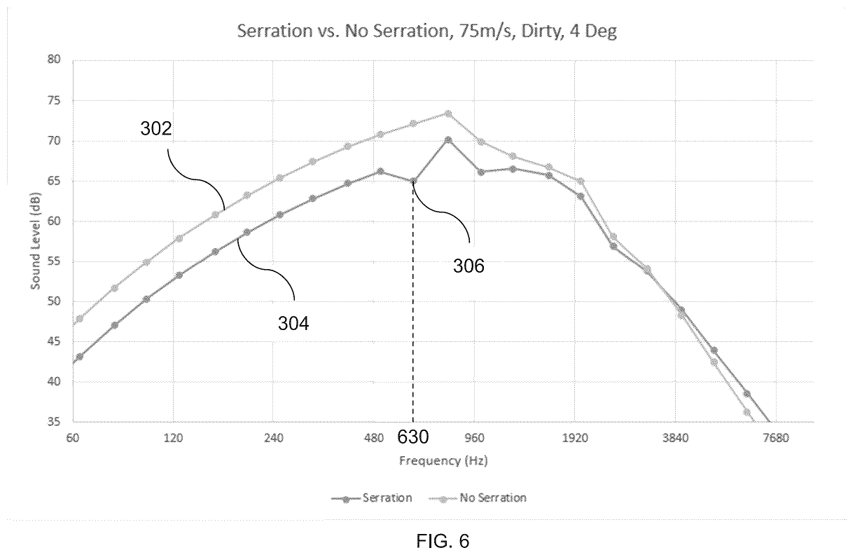

FIG. 6 is a two-dimensional graph showing a sound level (dB) produced by blade 100 as a function of frequency (Hz). The two-dimensional graph was created based on data generated through wind tunnel testing. The fan used for the wind tunnel testing produced a wind speed of 75 m/s. Trend line 302 represents the sound level (dB) for a blade 100 that does have structure 200 retrofitted onto or integrated into the blade 100. Trend line 304 represents the sound level (dB) for a blade 100 that has structure 200 retrofitted onto or integrated into the blade 100. As depicted, there is less sound produced in a blade 100 having structure 200 than a blade 100 not having structure 200 when the frequency is below approximately 3000 Hz. As depicted, there is a significant reduction at point 306 when the frequency is at 630 Hz. Point 306 may be a location where destructive interference is occurring to the greatest effect.

As observed in FIG. 6, there has been a technical improvement between the no serration control test sample and the serration test, namely a reduction in sound level (dB).

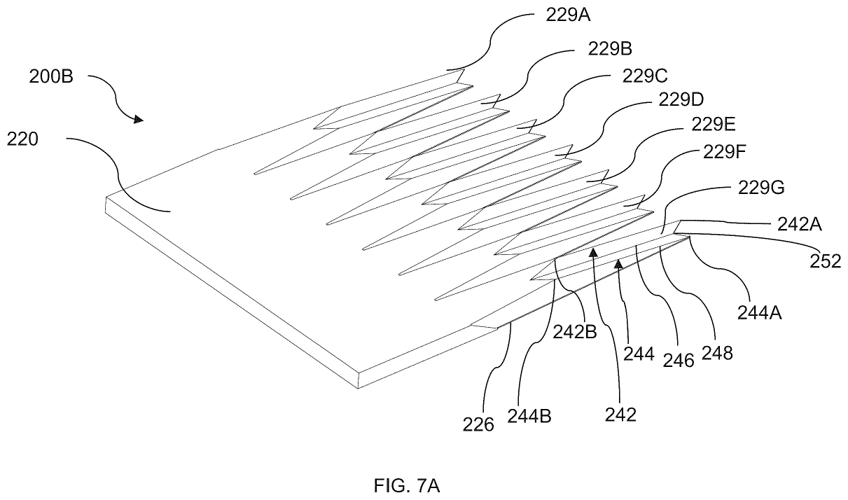

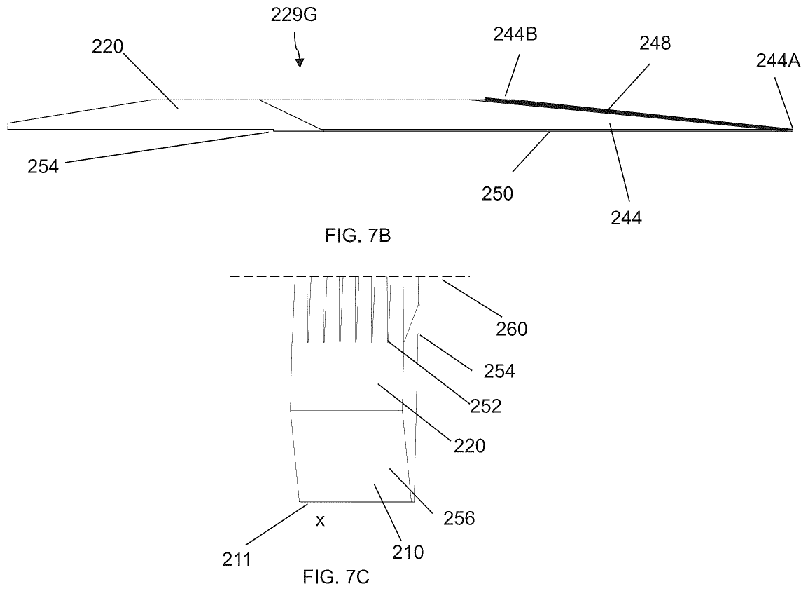

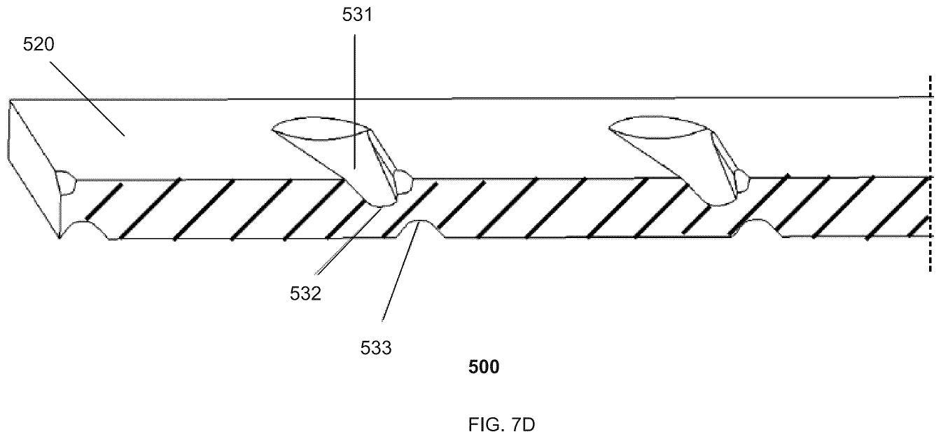

FIG. 7A is a side perspective view of section 200B according to an embodiment of the invention. Section 200B may contain a base section 220 and a plurality of projections 229A-229G.

For simplicity purposes, the construction of projections 229A-229G will be explained in relation to projection 229G. However, it should be understood that each of the projections 229A-229F may be of a similar construction. As depicted, secondary trough 252 may be defined between the first peak 242 and the second peak 244.

As depicted, a tip of the first peak 242 may be chamfered progressively from a first height 242A to a second height 242B along a midline 246. First height 242A may be less than second height 242B. Similarly, a tip of the second peak 244 may be chamfered progressively from a first height 244A to a second height 244B along a midline 248. First height 244A may be less than second height 244B. As illustrated, second peak 244 may define part of edge interface 226 of section 200B. The chamfered profile of projection 229G may allow for a progressive reduction in space over time for the two different flow velocities to interact and come together in a more gradual way to prevent any interaction which would produce increased turbulence and noise. In this way, the chamfered profile of projection 229G may be useful in reducing the onset of noise as compared to a blunt structure that contains 90-degree angles. Accordingly, the chamfered variation provides a practical benefit and the type of chamfering (e.g., the angles and shape profile) may impact the level of improvement.

FIG. 7B illustrates a side view of a projection 229G. As illustrated, second peak 244 may be chamfered along midline 248 between a first height 244A and a second height 244B. In some embodiments, the tip of the projection 229G may be rounded (shown at first height 244A). In some embodiments, the base section 220 may contain a recess 254 to align section 200B with the trailing edge 120 of the blade 100. For installation, the recess 254 may be used to mate the base section 220 with the blunt trailing edge 120 of the blade 100.

FIG. 7C illustrates a top-down perspective view of a portion of section 200B. As illustrated, the base section 220 may be chamfered at an end portion 210 such that the edge 211 of the base section 220 meets flush with the surface X of the trailing edge 120 of the blade 100. The degree of chamfering, which determines where a maximal thickness distances 256 starts, is related to a distance from a trough 252 and local input parameters. As described above, it is the local flow velocity which determines the chamfering geometry. When the base section 220 is applied at a further radial position, the chamfer angle would ideally be smaller, to allow for a reduction in flow vector change, coming from the trailing edge 120 given the increased local flow velocity. The acute chamfer angle can range from 1 degree to 10 degrees. Less severe means that the length from an edge 211 to a maximal thickness distances 256 may be increased, meaning that the thickness is built up more gradually. The edge 211 may be exhibited through the use of a sinusoidal, curved or undulating flow surface, such that the flow may be guided to move to specific useful locations over the base section 220 that align with one or more troughs 252. This flow may adhere to the surface of the base section 220, and thus not create turbulence and unwanted noise.

As the local flow velocity is increased, the degree of chamfering should be less in these projections which are at a further radial position. Firstly, the thickness of said projections is less, so there is a reduced thickness to mate up with the trailing edge of the blade, and secondly, the flow vector should not be altered that much as any large change risks tripping the flow to turbulent flow. This arrangement ensures that there is as little interference as possible with the natural flow of air moving over the suction side 160 and pressure side 150 of the elongate body of the blade 100 at the point of the trailing edge 120.

FIG. 7D illustrates a cut-away perspective view of an example trough geometry 500 for a structure of alternating projections and troughs 200. FIG. 7D can be compared to FIG. 7C, with the cut-away at 260. According to an embodiment, there exists a start of a depression 531 beginning at a base section 520 and extending towards an apex of a trough 532. Said depression exists on a pressure side 531 532 and a suction side 533 of a structure 200, 300, with the depressions 531, 532, 533 being diagonal to each other to guide the flow into a preferential downstream formation that would transmit less acoustic energy. The depressions 531, 532, 533 may grow in depth as one travels from a base section 520 towards an apex of a trough 532. Again, this is to promote as little interference as possible with the natural flow path of the air moving over the suction side 160 and pressure side 150 of the elongate body of the rotor blade 100 at the point of the trailing edge 120. The trough on the suction side is offset from the one on the pressure side. This directs the flows so that they do not collide at 231, but swirl around each other. Further, a depression located more towards a tip section 140 may have a smaller depression of around 1 mm, whereas a depression located more towards a root 130 may have a greater depression of around 5 mm. The reason for this is local flow speed. The flow near the tip has a much higher velocity and cannot withstand large changes in its vector without becoming turbulent, whereas the flow near the root can withstand higher degrees of vector change.

Such a geometry configuration/geometric configuration may also be a consideration in both a primary trough 231 and a secondary trough 233. The creation of micro-vortices and associated aerodynamic changes of the associated rotor blade 100 may be beneficial in the improvement of aerodynamic lift over drag performance as well as wake recovery. In this case, the improvement in aerodynamic performance and reduction of drag through the creation of these micro-vortices leads to a greater decrease in flow velocity behind the rotor. When this flow velocity is then contrasted with the mean freestream flow velocity, a greater differential is found; this is turn, improves momentum transfer in the wake downstream, and reduces wake impacts on downstream turbines by increasing the flow velocity that they harvest energy from.

A depression, for example, can be a slight depression, and can be provided in the two or more alternating troughs. The depressions, when diagonal with one another, can elicit a vortex flow phenomenon that improves the aerodynamic qualities of the airfoil operating alone or in combination with other airfoils. The airfoils can operate in a system or array of airfoils, for example, that are positioned to take advantage of the vortex flow phenomenon.

For example, for a wind turbine, it improves the performance of the turbine but also improves the wake, and thus improves the performance of a downstream turbine.

FIGS. 8A, 8B, 8C and 8D illustrate side views of section 200B wherein the projection 229G is coupled to the trailing edge 120 of blade 100 at the pressure side 150, the suction side 160, and on both the pressure and suction sides 150,160, respectively. As shown in FIGS. 8A-8C, a number of variations are possible as to where structures can be coupled and/or attached together.

In some embodiments, as depicted in FIG. 8A, an end portion 210 of base section 220 of section 200B is chamfered between a surface “X” of the trailing edge 120 on a pressure side 150 until it meets with a top portion of base section 220. Said end portion 210 may be integrally formed with base section 220 or may be bonded to the top portion of base section 220.

In another embodiment, an alteration as prescribed in FIG. 8B shows the same, except that the section 200B is coupled onto the suction side 160 of blade 100.

As illustrated in FIGS. 8A and 8B, base section 220 may be parallel to the surface “X” of pressure side 150 or suction side 160, respectively. According to another embodiment, an end portion 210 of base section 220 may attach to both a pressure side 150 and suction side 160, enabling the base section 220 to be parallel to the chord length 125. In an alternate embodiment, the base section 220 may also be at some angle to the chord length 125.

The end portion 210 of base section 220 may be coupled to surface(s) “X” of blade 100 using adhesives. The adhesive may be made from a biological or non-biological based material such as UV-resistant ABA or ABS. The end portion 210 may be made from a flexible material that can conform to the local thickness of the trailing edge 120. The technical benefit of using adhesives and having an end portion 210 made from a flexible material is that it allows coupling without requiring knowledge of the exact thickness of the trailing edge 120. Practically, this may reduce uncertainty during installing of structure 200. Installation may occur by applying adhesive to an end portion 210 of base section 220, aligning and securing the section 200B to the trailing edge 120 using the recess 254, and applying a contact force to adhere the section 200B to the trailing edge 120. Although FIGS. 9A-9C illustrate section 200B of structure 200 being coupled to blade 100, it should be understood that structure 200 may be integrally formed with blade 100.

In some embodiments, as depicted in FIG. 8D, a section 200B showing a projection 229G and a base section 220 may be at a relative angle ‘a’ to each other. Variations of angle a are possible, and a number of different non-limiting, illustrative variants are proposed below. While angles can be described, the angles may also vary depending on manufacturing tolerances and the manufacturing process. Other variations are contemplated.

The angle “a” is defined between the centerline 262 of the base section 220 and the centerline 261 of the projection 229G.

The centerline 262 in this case is parallel to the surface “X” of the pressure side 150 at the trailing edge 120, though the same is also interchangeable with the surface “X” of the suction side 160.

The angle ‘a’ may be between (+/−) 0.5 degrees and (+/−) 6 degrees. In some cases, the material choice of the base section 220 and the projection 229G may be such that in operation, the projection 229G may bend due to the aerodynamic forces on it and achieve the required angle “a”. In other cases, the material may be quite stiff, such that an angle “a” is desired in the design of the base section. This angle may be such to align the resultant airflow with the naturally occurring wake trajectory behind the projection 229G. This can be determined by the angle of attack of the airfoil. The best angle is thus a result of site-specific considerations of operating angles of attack for the blade (FIG. 2).

As example, a wind turbine operates at wind speeds below rated power most of the time, where the angle of attack of the blade (FIG. 2) is between −1 degrees and −3 degrees. Therefore, a desirable angle of attack would be −2 degrees in this circumstance.

As such, the angle “a” may be introduced in the design phase of the rotor blade (FIG. 2) to account for operational specifics of the turbine (FIG. 1) and also to reduce the resultant load on the section 200B and prevent peeling and delamination.

This peeling force could result in the section 200B becoming detached, thus negating the purpose of the invention. This peeling force comes about when there is a pressure differential between a suction side and pressure side of a projection 229G.

To reduce the impacts of this peeling force, a suitable material for the serration may be used that has sufficient flexibility to deflect into the resultant wake field, adjusting to the different pressure fields that are exerted onto it. This material may be a polyurethane or a thermoplastic polymer or elastomer that contains this degree of elasticity. A novel benefit of such a material is that, in reacting to the pressure differences around it, it passively achieves a desirable angle of attack.

Noise Modification Variations: In an alternate variation, instead of, or in addition to negating noise, the plurality of projections and troughs instead are adapted to produce or modify noise such that it is generated in a desired frequency band.

The frequency range for emissions would be 20-200 kHz. Humans can hear up to 20 kHz, but the average for adults is around 15-17 kHz. The intent for the technology is not to produce a frequency band that would be audible and annoying to people, but one that sends a signal to a bat or other animals that there is a large object in their way, and they should steer clear. As most bats echo-locate between 20-80 kHz, this would be the predominant frequency bands for emanation of noise/sound, but the technology can also be tunable such that a particular species can be targeted.

As example, a brown bat uses a call that is between 25-30 kHz, so if there was a known population to protect, one could apply serrations that would produce that band. Further, as different bat species are known to fly at different wind speeds, the designated atmospheric wind speed determined through the turbine's SCADA data and the associated effective local wind speed on the turbine blade (determined through RPM via the controller) can be used to inform the exact geometry of the feature.

In this variation, the plurality of projections and troughs are structured such that the generated noise is in the desired frequency band that is based at least on a frequency band that is repulsive to various types of animals, such as birds, bats, fish, insects (e.g., a high frequency band that is outside of the realm of human hearing), given a designated local wind speed.

The geometry for this feature would be located in the outer most radial section, near the blade tip of the serration that is modified. There are two reasons for this—firstly, there is a desire to want your noise source to capture the full swept area of the rotor for the animals (e.g., bats) should avoid, to create a ‘clearance zone’ and second, this is the area of the highest velocity flow, which is able to produce the highest frequency soundwaves.

The serration geometry would contain a geometric feature that would produce the noise when air passes by or over it. The precise geometry of the feature determines the noise frequency emitted, with smaller geometric features producing higher frequency emissions. The geometry used to generate a specific frequency may be an aperture, hole, slit, filet, recess, bevel or the like.

By way of analogy, this approach can be conceptualized as blowing on the top of a glass bottle.

FIG. 9 shows an example serration with deterrence mechanisms built-into the serration that are adapted to create sound at particular frequencies. FIG. 9, 902 shows an example aperture/hole whose diameter is selected to generate the sound at the deterrence frequency ranges. Different sizes of apertures are possible to generate sound at different frequency ranges, and in some embodiments, a combination of different apertures is used together. The apertures work together with the serrations in concert to improve the sound profile, by creating sound at frequencies of interest, and interfering with undesirable noise, and accordingly, in an embodiment, the serration has both the serration geometry, and the noise generation apertures. The apertures may be positioned on the distal serration, but in some embodiments, the apertures may be positioned on a plurality of serrations near the distal edge (e.g., not limited just to the last serration). Additional apertures allow for different amplitudes of sound to be generated, and can be adapted, for example, to the particular species that are targeted for deterrence.

Deterrence is desirable because an impact on incident wildlife can be reproduced. For example, birds and bats, or insects, could be desirable in an ecosystem and if they are deterred by the noise, injuries can be reduced or prevented, improving the adoption of green technologies.

Example Approaches for Manufacture and Application of Structure: Section 200B may be manufactured using injection molding, resin infusion, laser or water jet cutting or 3D printing. Alternative approaches are also contemplated, such as stamping, materials forming, etc.

In an embodiment, structure 200 may be made by injection moulding, whereby a design is replicated in tooling, with said tooling being able to withstand the manufacture of multiple parts. The material used in injection moulding may be suitable for use on a wind turbine and may include UV-resistant plastic.

An example of this material may be a thermoplastic polyurethane (TPU), which also has the beneficial property of being recyclable. TPU materials are pliable, which has beneficial aspects in that during installation they are less likely to break and during operation they bend with the airflow as the blade of the wind turbine alters its RPM, speed and angle of attack. This allows for increased performance and reduced loads on the wind turbine. In a practical variation where the structure 200 is pliable (e.g., not necessarily TPU), the structure 200, can in operation, “bend” due to stresses and forces acting upon it to a specific angle as noted herein. This can be useful in an approach where the material is specifically selected or provided with a geometry such that this occurs at the particular wind speed or combination of forces acting upon the structure 200.

The bending can be permanent or temporary (e.g., only when the forces are acting upon it). In another variation, the geometry of the structure can be adaptive and modifications can be made such that the amount of pliability or bend can be controlled either during the manufacturing process or subsequent thereof. An example adaptation to control an amount of pliability can include controlling a material composition of the materials used, or a material structure thereof, such as through the controlling the manufacturing process to change an underlying ratio, structure, or molecular weight of the underlying compounds, or other manufacturing process parameter. The manufacturing process, can include changing the way the internal lattice structures operate together to modify intermolecular forces, using different combinations of plasticizers, using different combinations of materials, changing polymer processing approaches (melting, injecting, shaping, cooling times, temperatures), etc. These process parameters can be combined with expected operational characteristics, such as RPM, speed and angle of attack to configure the pliable characteristics to match a desired angle. These can be combined with turbine control and sensor feedback to aid in improving the overall efficiency of the system.

Materials such as TPU also contain a beneficial characteristic in that they are able to adapt to minute imprecisions in a mould. In this way, the surface finish or surface texture may be modified to obtain beneficial properties. An example of one such property is the creation of hydrophobic surfaces that permit self-cleaning functionality. In biomimetics, this is known as a ‘lotus effect’ as lotus leaves displace hydrophobic properties which allows rain to run off the surface of the leaf, taking dirt and dust with it. As wind turbines are exposed to contaminants in the atmosphere that can impact their performance long term, hydrophobic traits are beneficial to structures like the present invention that are applied to airfoils. The surface texture may be formed through material deposition or material removal by way of lasers which can achieve the granularity required for such surface properties to become manifest. In addition to applying surface texture to a mould, surface texture may also be applied directly to the TPU by way of lasers or through the application of pressure while the TPU is still malleable.

In a further variation, the pliable characteristics can be modified in an on-demand based approach, whereby, instead of setting it at time of manufacture, certain characteristics can be modified after installation. This allows for increased flexibility in deployment. These modifications can include configuring the thermoplastic by reprocessing the thermoplastic after manufacture to change characteristics of the thermoplastic, or attaching or modifying physical shapes to change bending behavior.

This structure 200 may contain alignment tabs that allow for easy installation and alignment with the trailing edge of the wind turbine blade. Utilizing double-sided adhesive tape just in front of the tabs, an adhesive may be applied to the base section and the structure adhered to the surface of the blade's trailing edge.

The double-sided tape acts as a dam in this way, to prevent adhesive from spilling out. Further, tape cut into a zig-zag pattern may be applied onto the leading edge of the base section to act in partnership with the plurality of adjacent projections, guiding flow towards the troughs to enhance their effectiveness in operation.

Structure 200 is composed of multiple sections 200A, 200B, 200C, 200D, 200E, 200F each being between 490 mm and 510 mm in length, such that they present no obstacles of handling while at height on the wind turbine blade.

A selection of multiple variants of sections 200A to 200F can be chosen that can represent variations of d′, d″, w′ and w″ (e.g., an optimal combination of d′, d″, w′ and w″) for the given local average blade section of their use on the wind turbine blade. There can be different optimal combinations for a given use scenario.

In this way, as the turbine blade size changes for different sized turbines, a different allotment of sections 200A to 200F may be chosen that suit or are approximately tailored for the specific turbine type and site requirements. There may be a level of imprecision due to practical non-idealities that arise.

Noise reduction, power improvement or the generation of certain noise signatures to deter bats may be beneficial for the specific site chosen for its use. As a non-limiting example, during experimentation, it was found that a candidate approach that yielded good results included having each blade composed of a selection of sections 200A to 200F that, taken together, correspond to 33% of the blade length. Other variations are possible.

In other embodiments, structure 200 may be manufactured using 3D printing. The material used in 3D printing may be suitable for use on a wind turbine and may include UV-resistant plastic. To manufacture structure 200 using 3D printing, a design file may be first uploaded to a computer, the computer then sends a print command to a 3D printer, the 3D printer then makes the structure 200 pursuant to its method of material adhesion.

Lastly, another method of manufacturing may be laser or water jet cutting whereby a design file is uploaded to a computer, and the computer then sends a cutting command to a laser or waterjet cutting head, which then conforms to the design file.

The design file in any of the cases above may be refined through computational fluid dynamics (CFD) simulations, which may be used to estimate the relative sound production or aerodynamic properties of the above-described structure 200 and configurations to the rotor blade of a horizontal-axis wind turbine.

In other embodiments, structure 200 may be adhered to an airfoil using adhesives or double-sided tape. In other examples, a single-sided tape may be used on any edge of a base section 220 that additionally gives beneficial aerodynamic properties. The tape may interact with the boundary layer flow conditions and result in beneficial flow characteristics. This may include covering any sharp edges that would cause the flow to become turbulent, or the tape may be cut to take advantage of the tape's thickness and low profile, forcing the flow to move in beneficial ways that are identical to the present invention. Namely, the tape may be cut in a zig-zag or V-shaped fashion that causes the flow to form a small vorticity at the bottom of the V. The application may occur in the context of blade manufacturing in a factory, or in the context of a retrofit onto the airfoil, either on the ground or in the air.

In other embodiments, structure 200 may be aligned to the trailing edge of an airfoil through the use and placement of an object in addition to the structure 200. This object may be a thick foam-tape of minimal width, in that the foam-tape may be attached to the structure 200 and allow an installation technician to a-but the curved trailing edge or the airfoil receiving structure 200 and act as a guide to placement in the chord orientation of the airfoil. This object may be placed on the structure 200 after manufacturing and may be akin to the integral recess 254 in FIG. 7B. This recess 254 or notch that is taken out of the structure 200 may also act as a guide in the placement of the structure 200.

It should be understood that the above-described structure 200 and configurations to the rotor blade of a horizontal-axis wind turbine can also be applied to vertical-axis wind turbines, and both of any scale.

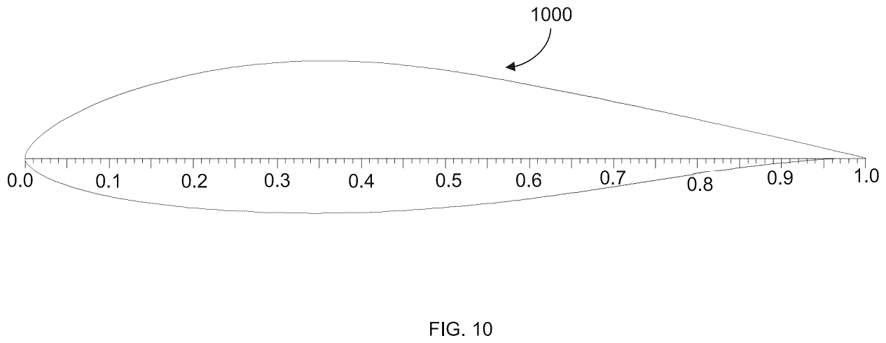

FIG. 10 is an example airfoil/flow control shape, for reference. As shown in diagram 1000, the shape of the airfoil leads to technical challenges in assessing the boundary layer, which in some embodiments, numerical methods are utilized to approximate or estimate various characteristics of the boundary layer.

Such improvements described in various embodiments above may apply equally well to various other types of airfoil, not depending on the aerodynamic design thereof, mutatis mutandis, with such mutations as being relevant, including but not limited to, high altitude wind power (HAWP) devices, tidal turbines, kite wind turbines, energy kites, urban wind turbines, airplane wings, seacraft wings, gliders, drones, and other things. The approaches described herein may be applied to wind turbines having fewer or more blades than described by way of example in order to increase the operational efficiency and noise reduction capabilities of a wind turbine, to decrease vibration, loads, maintenance costs and mechanical wear, and to increase the scalability and marketability of such wind turbines.

The above-described airfoil configurations may be employed in aircraft such as commercial airliners, military jet aircraft, helicopter blades, helicopter wings, civilian airplanes, drones, and other similar aircraft.

It is observed that commercial airliners, civilian airplanes, drones, helicopter blades and the like, would have a plurality of projections and troughs of a similar size-to-chord ratio to those of modern wind turbines, taking into consideration local flow velocity and the desired frequency range to be impeded.

The above-described configurations of structures for traversing a fluid environment may be applicable in combination with one or more of the configurations disclosed in co-pending PCT Patent Application No. PCT/CA2015/050740 to Ryan Church, filed on even date, entitled “STRUCTURE WITH RIGID WINGLET ADAPTED TO TRAVERSE A FLUID ENVIRONMENT,” the contents of which are incorporated herein by reference, or in co-pending PCT Patent Application No. PCT/CA2015/050739 to Ryan Church, filed on even date, entitled “FLUID-REDIRECTING STRUCTURE,” the contents of which are incorporated herein by reference.

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

Wind tunnel specifics: Recently, a blade profile with a chord of 914 mm was tested in an aero-acoustic wind tunnel at three wind speeds: 30 m/s, 50 m/s and 70 m/s. The profile was tested with and without a turbulator strip intended to simulation real-world turbulent wind conditions.

An example of structure 200 with a d′ of 191 mm, d″ of 7.5 mm, w′ of 41 mm and w″ of 41 mm was applied to the trailing edge of the profile and tested at various angles of attack between +/−15 degrees. The results from testing indicated that the average sound power level reduction was on the order of 8 dB(A).

Following this, field trials took place that placed structure 200 with variations of d′, d″, w′ and w″ for sections 200A, 200B, 200C, 200D, 200E, 200F to the trailing edge of a wind turbine blade. The results of noise testing show the industrial applicability and demonstrated utility in the approaches proposed herein, as significant reductions in noise were seen.

1. A set of projections coupled to or forming a portion of a trailing edge of an airfoil and adapted to modify an audible noise output of the airfoil, the set of projections comprising:
a plurality of adjacent projections, each projection of the one or more projections having two or more peaks and an intermediate trough between the two or more peaks, and one or more troughs between adjacent projections;
a base section of the adjacent projections attached to a pressure or suction side of the trailing edge of the airfoil; and
wherein a distance (d) between a lowest point of the intermediate and a lowest point of the one or more troughs between adjacent projections is between 5% and 45% of a chord length of the airfoil and is determined based on a relation between a product of at least a speed of sound and a boundary displacement layer thickness, and a product of at least a constant and a total local wind speed.

2. (canceled)

3. (canceled)

4. The set of projections of claim 1, wherein the two or more peaks comprise only two peaks, and a width between the two peaks (w) is determined as a relation between at least d′ and a dominant frequency to be reduced, wherein the dominant frequency is between 250 Hz-800 Hz.

5. The set of projections of claim 1, wherein d′ varies at different regions of the airfoil, and falls within 15% and 25% of the chord length of the airfoil.

6. The set of projections of claim 1, wherein the two or more peaks are deflected or rotated away from the centerline of the base section to confer an aerodynamic advantage.

7. The set of projections of claim 5, wherein the airfoil is geospatially apportioned into a plurality of separate portions, each portion having an approximated boundary displacement layer thickness, and wherein projections of the set of projections have a d′ determined based on the approximated boundary displacement layer thickness corresponding to the portion of the plurality of separate portions that the projections are coupled to or forming a portion of.

8. The set of projections of claim 5, wherein projections of the set of projections have a d′ determined based on the specific boundary displacement layer thickness corresponding to the region of the airfoil that the projections are coupled to or forming a portion of.

9. (canceled)

10. The set of projections of claim 1, wherein the set of project are manufactured using at least one of injection moulding, resin infusion, laser or water jet cutting, and 3D printing; and the two or more peaks and the intermediate trough are manufactured through a progressive chamfering process or injection moulding process.

11. (canceled)

12. (canceled)

13. The set of projections of claim 1, wherein the modification of the audible noise output includes generating destructive interference for a human audible sound frequency.

14-19. (canceled)

20. The set of projections of claim 1, wherein d′ is determined using the relation:
$${d}^{′} = \frac{{U}_{s} {\partial }_{BL}}{0.14 {U}_{L}}$$

21. The set of projections of claim 20, wherein Uₛ is determined based on an average operating temperature in a particular region of operation.

22. The set of projections of claim 4, wherein w′ is determined using the relation:
$${w}^{′} = \frac{{d}^{′} \times κ}{\frac{f}{3}} \times 1000$$

23-26. (canceled)

27. The set of projections of claim 1, wherein the adjacent projections and troughs contain a three-dimensional geometry having a pressure side and a suction side, the geometry on both sides being beveled from a midpoint to an external edge.

28. The set of projections of claim 27, wherein the base section designed to attach to the trailing edge of the airfoil on the pressure side or suction side, the three-dimensional geometry of this base section being chamfered or having tabs to integrate with the trailing edge of the airfoil.

29-32. (canceled)

33. The set of projections of claim 28, wherein, as measured from the edge of the base section, each secondary peak is a different length as its corresponding neighboring primary peak.

34. The set of projections of claim 27, wherein from root end to tip end along the trailing edge of the airfoil, a localized chordal spatial relationship between two adjacent troughs d′ remains the same for any two adjacent troughs.

35. The set of projections of claim 34, wherein there are multiple sections or groupings of adjacent projections and troughs on the airfoil, whereby the localized chordal spatial relationship between two adjacent troughs d′ remains the same for that section or grouping.

36. (canceled)

37. (canceled)

38. The set of projections of claim 2, whereby the two or more adjacent troughs contain a slight depression on the pressure side along with a slight depression on the suction side, the depressions being diagonal to each other to elicit a vortex flow phenomenon that improves the aerodynamic qualities of the airfoil operating alone or in combination with other airfoils in a system.

39-51. (canceled)

52. The set of projections of claim 8 wherein the set of projections are manufactured using an elastic material that passively bends to align with the resultant airflow and wake trajectory behind the projection when acted upon by an aerodynamic force.

53. The set of projections of claim 1, wherein the projections are made from an elastic material that deflects in response to variable pressure fields, into the resultant wake field based on an operating angle of attack and blade conditions.

54-57. (canceled)

58. The set of projections of claim 1, further comprising a coupling surface of the base section adhesively coupled to the pressure or suction side of the trailing edge of the airfoil, wherein the finish or texture of the coupling surface is modified to obtain beneficial bonding and aerodynamic properties.
